(19) United States
(12) Patent Application Publication
(10) Pub. No.: US 2006/0188409 A1
(43) Pub. Date: Aug. 24, 2006

(54) Multi-well container positioning devices, systems, computer program products, and methods

(75) Inventors: Jim Yuchen Chang, San Diego, CA (US); James Kevin Mainquist, San Diego, CA (US)

Correspondence Address: QUINE INTELLECTUAL PROPERTY LAW GROUP, P.C., P O BOX 458, ALAMEDA, CA, 94501, US

(73) Assignee: IRM LLC, Hamilton Bermuda (HM)

(21) Appl. No.: 11/335,838

(22) Filed: Jan. 18, 2006

Related U.S. Application Data
(60) Provisional application No. 60/645,502, filed on Jan. 19, 2005.

(51) Int. Cl. B01L 3/00

(52) U.S. Cl. 422/102

(57) ABSTRACT

The present invention provides multi-well container positioning devices and systems. In certain embodiments, these devices and systems are structured to compensate for structural defects or irregularities of multi-well containers so that the containers are accurately positioned for further processing. In some embodiments, multi-well container positioning devices and systems include multiple chambers that can be used to retain multi-well containers in selected positions on the positioning devices in a desired sequence. In addition, related computer program products and methods are also provided.

### CROSS-REFERENCE TO RELATED APPLICATIONS

This application claims priority to and benefit of prior provisional patent application U.S. Ser. No. 60/645,502 filed Jan. 19, 2005, the disclosure of which is incorporated herein by reference in its entirety for all purposes.

### COPYRIGHT NOTIFICATION

Pursuant to 37 C.F.R. § 1.71(e), Applicants note that a portion of this disclosure contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### FIELD OF THE INVENTION

The present invention relates generally to object positioning, and more particularly, to devices, systems, computer program products, and methods for positioning and retaining multi-well containers for additional processing, including material transfer and assay detection.

### BACKGROUND OF THE INVENTION

To enhance the throughput of chemical synthesis and compound screening, these processes are often performed in parallel utilizing various multi-well container formats. Multi-well containers, such as microtiter plates, typically have many individual sample wells, for example, hundreds or even thousands of wells. Each well forms a container into which a sample or reagent is placed. Since an assay or synthesis can be conducted in each sample well, hundreds or thousands of assays or syntheses can be performed simultaneously using a single plate. Many commercially available microtiter plates are configured to meet industry standards in terms of well numbers (e.g., 96 wells, 384 wells, 1536 wells, and even higher well densities), well proportions, and overall plate dimensions. In addition, coupling the use of multi-well containers with automated processing systems typically further increases the number of compounds that can be synthesized and/or tested in a single day. To illustrate, automated equipment, such as automated material handling devices can receive appropriately configured multi-well containers and deposit samples or reagents into the wells. Other known automated equipment, such as robotic translocation devices can also facilitate the processing and testing of samples in multi-well containers.

In order to perform high numbers of assays in parallel with desired levels of reliability and reproducibility, a high throughput system generally needs to accurately, efficiently, and reliably position individual multi-well containers for processing. For example, multi-well containers must typically be placed precisely relative to material handling devices (e.g., fluid dispensers or the like) to allow materials, such as samples and reagents, to be deposited into the correct sample wells. An added level of complexity that is often confronted when attempting to accurately position multi-well containers is created by structural defects or irregularities, which are commonly present in the multi-well containers themselves. To illustrate, the structures of certain multi-well containers frequently include varying degrees of warping that can negatively affect the stability of container positioning and create well-depth variations relative to, e.g., material handling and/or washing devices. Positioning errors, whether due to incorrect multi-well container placement, container structural defects, or combinations thereof, of only a few thousandths of an inch can result in, e.g., a sample or reagent being dispensed into a wrong sample well, inaccurate amounts of material being dispensed into and/or removed from a well, among other unintended consequences. Such mistakes can lead to biased test results, which may be relied upon for critical decision making, such as a course of medical treatment for a patient. Moreover, even minor positioning errors may cause a needle, pin, or tip of a material handling and/or washing device to collide with a multi-well container surface, which can damage the device and the multi-well container.

Many conventional automated positioning devices lack sufficient positioning accuracy and precision to reliably and repeatably position high-density multi-well containers for automated processing. In addition, these pre-existing devices generally do not account for multi-well container structural variations, which can also lead to positioning errors. For example, typical robotic systems are generally capable of achieving a positioning tolerance of about one mm. Although such a tolerance is adequate for certain low well density containers, such a tolerance is often inadequate for high-density containers, such as a microtiter plate with 1536 or more wells. To illustrate, a positioning error of one mm along an x- or y-axis for a 1536-well microtiter plate could cause a sample or reagent to be deposited entirely in the wrong well, or cause damage to system components. Further, a positioning error due, e.g., to variability along a z-axis of a positioned multi-well container can result in inaccurate amounts of material being removed from wells by material removal or washing devices.

From the foregoing, it is apparent that devices that can be utilized to precisely and accurately position multi-well sample containers for processing are highly desirable. In addition, automated systems that include these devices, computer program products, and related methods of positioning multi-well containers are also desirable. These and a variety of additional features of the present invention will be evident upon complete review of the following disclosure.

### SUMMARY OF THE INVENTION

The present invention relates generally to positioning devices for positioning and retaining multi-well containers in desired positions with greater precision and accuracy than many preexisting devices. Positioning precision and accuracy along the three translational axes of a multi-well container are often threshold considerations in determining whether a container of a given well density can be utilized in a particular system and/or process. The throughput and reliability of syntheses, assays, screens, or other processes performed in parallel is often limited by devices that cannot precisely and accurately position higher well density containers, such as those including over 1000 wells. In certain embodiments, the positioning devices of the present invention include multi-well container stations that are structured to position essentially any multi-well container, including such high-density containers.

In one aspect, the invention provides a multi-well container positioning device. The multi-well container positioning device includes at least one support structure having at least one multi-well container station. The multi-well container station includes at least one vacuum plate that is structured to support at least one multi-well container. At least one, but typically more than one, orifice is disposed through the vacuum plate. The orifice is configured to substantially align with a region of a bottom surface of the multi-well container that is disposed between at least two adjacent wells of the multi-well container when the multi-well container is positioned on the vacuum plate in a selected position. Regions between adjacent wells typically have greater structural strength or integrity than regions disposed directly beneath the wells of a given multi-well container. In some embodiments, for example, the orifice is configured to substantially align with a region of the bottom surface of the multi-well container that is disposed between four adjacent wells of the multi-well container when the multi-well container is positioned on the vacuum plate in the selected position. To further illustrate, a center of the orifice and a midpoint of the region of the bottom surface of the multi-well container that is disposed between the adjacent wells are typically substantially coaxial with one another when the multi-well container is positioned on the vacuum plate in the selected position. In addition, the multi-well container station also includes at least one chamber that communicates with the orifice such that when negative pressure is applied in the chamber and the multi-well container is positioned on the vacuum plate in the selected position, the applied negative pressure retains the multi-well container in the selected position on the vacuum plate.

In another aspect, the invention provides a multi-well container positioning device that includes at least one support structure having at least one multi-well container station. The multi-well container station includes at least one vacuum plate that is structured to support at least one multi-well container in which at least two orifices are disposed through the vacuum plate. The multi-well container station also includes at least two chambers that communicate with different orifices disposed through the vacuum plate such that when negative pressure is applied in at least one of the chambers and when the multi-well container is positioned on the vacuum plate, the applied negative pressure retains the multi-well container on the positioning device.

The multi-well container positioning devices described herein include various embodiments. In some embodiments, for example, multi-well container positioning devices include multiple multi-well container stations. Optionally, the multi-well container station includes a heating element that adjustably regulates temperature in one or more wells of the multi-well container when the multi-well container is positioned on the vacuum plate and the heating element is operably connected to a power source. In certain embodiments, the multi-well container positioning device includes at least one position sensor coupled to the support structure. The position sensor is structured to detect the position of the multi-well container when the multi-well container is positioned on the vacuum plate. In some embodiments, the multi-well container station comprises at least one lip surface disposed at least partially around the vacuum plate. The lip surface is typically recessed relative to the vacuum plate and is structured to receive a registration edge of an outer wall of the multi-well container when the multi-well container is positioned on the vacuum plate. Optionally, the multi-well container station includes at least one switch (e.g., a vacuum-actuated switch, etc.) that generates a signal that indicates when the multi-well container is positioned in the selected position on the vacuum plate.

In some embodiments, multiple orifices are disposed through the vacuum plate of the multi-well container positioning devices described herein. Typically, each of the orifices is configured to substantially align with a different region of the bottom surface of the multi-well container that is disposed between two or more adjacent wells of the multi-well container when the multi-well container is positioned on the vacuum plate in, e.g., the selected position. When multi-well container positioning devices comprise multiple chambers, at least two of the chambers generally communicate with different orifices disposed through the vacuum plate. In some of these embodiments, for example, the chambers are concentrically disposed in the multi-well container station.

Typically, applied negative pressure draws at least a portion of the bottom surface of the multi-well container toward the orifice to compensate for one or more structural defects or irregularities of the multi-well container, when the negative pressure is applied in the chamber and the multi-well container is positioned on the vacuum plate, e.g., in the selected position. In some embodiments, for example, the vacuum plate contacts the bottom surface of the multi-well container, which bottom surface underlies a well area of the multi-well container, when the multi-well container is positioned on the vacuum plate in the selected position. In these embodiments, the applied negative pressure substantially conforms a shape of at least a portion of the bottom surface of the multi-well container to a contour of at least a portion of the vacuum plate, when the negative pressure is applied in the chamber and the multi-well container is positioned on the vacuum plate, e.g., in the selected position. To further illustrate, the applied negative pressure substantially flattens at least a portion of the multi-well container, when the negative pressure is applied in the chamber and the multi-well container is positioned on the vacuum plate, e.g., in the selected position in certain embodiments.

In some embodiments, the multi-well container positioning devices described herein include at least one negative pressure source (e.g., a vacuum source, etc.) operably connected to the chamber or chambers. In certain embodiments, for example, multi-well container positioning devices include multiple chambers operably connected to the negative pressure source via at least one valve that regulates the negative pressure applied by the negative pressure source in one or more of the chambers. Typically, at least one controller is operably connected to the negative pressure source. The controller is generally configured to control the negative pressure applied by the negative pressure source. In some embodiments, multi-well container positioning devices include multiple chambers and multiple negative pressure sources. In these embodiments, the negative pressure sources typically communicate with different chambers. Further, the controller is generally operably connected to each of the negative pressure sources. The controller typically comprises at least one logic device having one or more logic instructions that direct the negative pressure sources to apply pressure in two or more of the chambers substantially simultaneously or in a selected sequence.

In certain embodiments, the multi-well container station of the multi-well, container positioning devices described herein comprises at least one alignment member that is positioned to engage an inner wall of an alignment member receiving area of the multi-well container when the multi-well container is positioned on the vacuum plate. Typically, the multi-well container station comprises multiple alignment members extending from and/or proximal to the vacuum plate and in which at least two of the alignment members are positioned to engage different inner walls of the alignment member receiving area of the multi-well container when the multi-well container is positioned on the vacuum plate. In some embodiments, the multi-well container station comprises multiple alignment members that together form a nest that is structured to receive the multi-well container when the multi-well container is positioned on the vacuum plate. Optionally, at least one of the multiple alignment members comprises an angled surface that is configured to direct the multi-well container into the nest when the multi-well container is placed into the nest. In certain embodiments, the alignment member comprises a curved surface that is structured to engage the inner wall of the alignment member receiving area of the multi-well container. To further illustrate, the alignment member optionally comprises a locating pin that extends from or proximal to the vacuum plate.

In some embodiments, the multi-well container positioning devices described herein include one or more pushers coupled to the support structure, which pushers are configured to push the multi-well container into contact with the alignment member when the multi-well container is positioned on the vacuum plate. Typically, multiple pushers are coupled to the support structure. In these embodiments, at least two of the pushers are generally configured to push the multi-well container in different directions when the multi-well container is positioned on the vacuum plate. At least one controller is generally operably connected to at least one of the pushers. The controller directs the pusher to push the multi-well container into contact with the alignment member when the multi-well container is positioned on the vacuum plate. In certain embodiments, at least one of the pushers comprises a low friction contact point (e.g., a roller, etc.) that is structured to contact the multi-well container when the multi-well container is positioned on the vacuum plate. Optionally, the multi-well container positioning devices described herein include at least one lever arm pivotally coupled to the support structure by a pivotal coupling. At least a first of the pushers is typically configured to push the lever arm such that the lever arm pivots to push the multi-well container into contact with the alignment member when the multi-well container is positioned on the vacuum plate. In certain embodiments, the lever arm is coupled to a resilient coupling (e.g., a spring, etc.) that causes the first pusher to apply a constant force to the multi-well container in order to push the multi-well container in a first direction when the multi-well container is positioned on the vacuum plate.

In another aspect, the invention provides computer program products. To illustrate, one computer program product includes a computer readable medium having one or more logic instructions for positioning a multi-well container on a vacuum plate of a multi-well container positioning device such that at least one orifice disposed through the vacuum plate substantially aligns with a region of a bottom surface of the multi-well container that is disposed between at least two adjacent wells of the multi-well container using at least one pusher. In some embodiments, the computer program product also includes at least one logic instruction for applying negative pressure through the orifice such that a shape of at least a portion of the bottom surface of the multi-well container substantially conforms to a contour of at least a portion of the vacuum plate using at least one negative pressure source. Another exemplary computer program product includes a computer readable medium having one or more logic instructions for: receiving at least one input selection of an applied negative pressure to multiple chambers of a multi-well container positioning device that is substantially simultaneous or that is in a selected sequence, and applying negative pressure to the chambers of the multi-well container positioning device with a negative pressure source in accordance with the input selection. In some embodiments, the computer program product includes at least one logic instruction for pushing at least one multi-well container into a selected position on a vacuum plate of the multi-well container positioning device using at least one pusher. Optionally, the computer program product includes at least one logic instruction for receiving at least one input pressure level to apply to one or more of the chambers of the multi-well container positioning device.

In another aspect, the invention provides a system that includes at least one multi-well container positioning device comprising at least one support structure having at least one multi-well container station. The multi-well container station includes at least one vacuum plate that is structured to support at least one multi-well container in which at least one orifice is disposed through the vacuum plate. The orifice is configured to substantially align with a region of a bottom surface of the multi-well container that is disposed between at least two adjacent wells of the multi-well container when the multi-well container is positioned on the vacuum plate in a selected position. The multi-well container station also includes at least one chamber that communicates with the orifice. In some embodiments, the multi-well container positioning device comprises multiple multi-well container stations. The system also includes at least one negative pressure source (e.g., a vacuum source, etc.) operably connected to the chamber. The negative pressure source is configured to apply negative pressure in the chamber to retain the multi-well container in the selected position. The system also includes at least one material handling device. The material handling device typically comprises a fluid handling device (e.g., a pin tool, a pipettor, and/or the like). In addition, the system also includes at least one controller operably connected to the negative pressure source and to the material handling device. The controller directs the negative pressure source to apply negative pressure in the chamber of the multi-well container positioning device and the material handling device to dispense material into and/or remove material from selected wells of the multi-well container when the multi-well container is positioned on the vacuum plate in the selected position.

In another aspect, the invention provides a system that includes at least one multi-well container positioning device comprising at least one support structure having at least one multi-well container station. The multi-well container station includes at least one vacuum plate that is structured to support at least one multi-well container in which at least two orifices are disposed through the vacuum plate. The multi-well container station also includes at least two chambers that communicate with different orifices disposed through the vacuum plate. The system also includes at least one negative pressure source operably connected to the chambers. The negative pressure source is configured to apply negative pressure in the chambers to retain the multi-well container in a selected position on the vacuum plate. The system further includes at least one material handling device, such as a fluid handling device (e.g., a pin tool, a pipettor, and/or the like). In addition, the system also includes at least one controller operably connected to the negative pressure source and to the material handling device. The controller directs the negative pressure source to apply negative pressure in the chambers of the multi-well container positioning device and the material handling device to dispense material into and/or remove material from selected wells of the multi-well container when the multi-well container is positioned on the vacuum plate in the selected position.

In some embodiments, the multi-well container stations of the systems described herein comprise at least one alignment member. In these embodiments, the multi-well container stations also typically include at least one pusher coupled to the support structure and operably connected to the controller. The controller generally further directs the pusher to push the multi-well container into contact with the alignment member when the multi-well container is positioned in the multi-well container station.

The systems described herein optionally include various additional components. In certain embodiments, for example, a system includes at least one robotic translocation device operably connected to the controller. The controller typically further directs the robotic translocation device to translocate multi-well containers to and/or from the multi-well container positioning device. In some embodiments, a system includes at least one translational mechanism coupled to the multi-well container positioning device. The translational mechanism is generally structured to translate the multi-well container positioning device along at least one translational axis. Optionally, a system includes at least one multi-well container washing device operably connected to the controller. In these embodiments, the controller generally further directs the multi-well container washing device to wash one or more selected wells of the multi-well container when the multi-well container is positioned on the vacuum plate in the selected position. In some embodiments, a system includes at least one detector operably connected to the controller. In these embodiments, the controller typically further directs the detector to detect one or more detectable signals produced in one or more selected wells of the multi-well container when the multi-well container is positioned in the multi-well container station.

In another aspect, the invention provides a method of positioning a multi-well container on a multi-well container positioning device. The method includes (a) placing the multi-well container on a vacuum plate of the multi-well container positioning device such that at least one region of a bottom surface of the multi-well container that is disposed between at least two adjacent wells of the multi-well container substantially aligns with at least one orifice disposed through the vacuum plate. In some embodiments, (a) comprises placing the multi-well container on the vacuum plate of the multi-well container positioning device such that multiple regions of the bottom surface of the multi-well container that are disposed between multiple sets of at least two adjacent wells of the multi-well container substantially align with multiple orifices disposed through the vacuum plate. The method also includes (b) applying negative pressure to the region of the bottom surface of the multi-well container through the orifice such that at least the region of the multi-well container is retained on the vacuum plate, thereby positioning the multi-well container on the multi-well container positioning device. Optionally, (b) comprises applying the negative pressure to the multiple regions of the bottom surface of the multi-well container through the multiple orifices such that the multiple regions of the multi-well container are retained on the vacuum plate. In certain embodiments, for example, (b) comprises applying the negative pressure to the multiple regions of the bottom surface of the multi-well container through the multiple orifices in a selected sequence. In some embodiments, (b) comprises applying the negative pressure to the region of the bottom surface of the multi-well container through the orifice such that a shape of at least a portion of the bottom surface of the multi-well container substantially conforms to a contour of at least a portion of the vacuum plate.

In another aspect, the invention provides a method of positioning a multi-well container on a multi-well container positioning device. The method includes (a) placing the multi-well container on a vacuum plate of the multi-well container positioning device in which at least two orifices are disposed through the vacuum plate. Optionally, (a) comprises placing the multi-well container on the vacuum plate of the multi-well container positioning device such that multiple regions of the bottom surface of the multi-well container that are disposed between multiple sets of at least two adjacent wells of the multi-well container substantially align with multiple orifices disposed through the vacuum plate. The method also includes (b) applying at least a first negative pressure to at least a first region of a bottom surface of the multi-well container through at least a first orifice such that at least the first region of the multi-well container is retained on the vacuum plate of the multi-well container positioning device. In addition, the method also includes (c) applying at least a second negative pressure to at least a second region of the bottom surface of the multi-well container through at least a second orifice such that at least the second region of the multi-well container is retained on the vacuum plate of the multi-well container positioning device, thereby positioning the multi-well container on the positioning device. In some embodiments, (b) and (c) comprise applying the first and second negative pressures to the first and second regions of the bottom surface of the multi-well container through the first and second orifices such that a shape of at least a portion of the bottom surface of the multi-well container substantially conforms to a contour of at least a portion of the vacuum plate. In certain embodiments, (b) and (c) are performed substantially simultaneously, whereas in others, (b) and (c) are performed sequentially.

The methods described herein include various embodiments. In some embodiments, for example, the multi-well container positioning device comprises at least one pusher and at least one alignment member, and (a) comprises pushing the multi-well container into contact with the alignment member with the pusher to align the multi-well container on the vacuum plate. Optionally, (a) comprises placing the multi-well container on the vacuum plate with a robotic translocation device. In certain embodiments, the methods include dispensing material into and/or removing material from selected wells of the multi-well container with a material handling device. Optionally, the methods include detecting one or more detectable signals produced in one or more selected wells of the multi-well container with a detector.

### BRIEF DESCRIPTION OF THE DRAWINGS

FIG. 1A schematically illustrates a material removal head of a multi-well container washing system accessing a warped multi-well container from cross-sectional views.

FIG. 1B schematically depicts cross-sectional views of a material removal head of a multi-well container washing system accessing a multi-well container in which warping of the multi-well container has been compensated for.

FIG. 2A schematically shows a cross-section through a portion of a multi-well container and a portion of a vacuum plate in which orifices of the vacuum plate are substantially aligned with regions of the bottom surface of the multi-well container that underlie the wells of the multi-well container.

FIG. 2B schematically shows a cross-section through a portion of a multi-well container and a portion of a vacuum plate in which orifices of the vacuum plate are substantially aligned with regions of the bottom surface of the multi-well container that are disposed between adjacent wells of the multi-well container.

FIG. 3 schematically shows a system from a perspective view according to one embodiment of the invention.

FIG. 4A schematically depicts a multi-well container station from a perspective view according to one embodiment of the invention.

FIG. 4B schematically depicts the multi-well container station of FIG. 4A from a partially exploded perspective view.

FIGS. 5A through 5I schematically illustrate various representative orifices that are each substantially aligned with regions of bottom surfaces of portions of multi-well containers that are disposed between adjacent wells of the multi-well containers from partially transparent bottom views.

FIG. 6A schematically depicts a multi-well container station from a perspective view according to one embodiment of the invention.

FIG. 6B schematically illustrates the multi-well container station of FIG. 6A without a vacuum plate.

FIG. 6C schematically shows the multi-well container station of FIG. 6A from a bottom perspective view.

FIG. 6D schematically depicts the multi-well container station of FIG. 6A from a bottom perspective view.

FIG. 6E schematically shows a multi-well container positioned on the multi-well container station of FIG. 6A from a top view.

FIG. 6F schematically illustrates a multi-well container positioned on the multi-well container station of FIG. 6A from a perspective view.

FIG. 7A schematically shows a multi-well container station from a perspective view according to one embodiment of the invention.

FIG. 7B schematically illustrates the multi-well container station of FIG. 7A from a top view.

FIG. 7C schematically depicts the multi-well container station of FIG. 7A from a side view.

FIG. 7D schematically shows the multi-well container station of FIG. 7A from a bottom perspective view.

FIG. 8A schematically depicts a multi-well container positioning device from a top perspective view according to one embodiment of the invention.

FIG. 8B schematically illustrates the multi-well container positioning device of FIG. 8A without a vacuum plate from a top perspective view.

FIG. 8C schematically depicts the multi-well container positioning device of FIG. 8A from a bottom perspective view.

FIG. 9A schematically shows a multi-well container positioning device that includes the support structure of FIG. 3 from a top view.

FIG. 9B schematically illustrates the multi-well container positioning device of FIG. 9A from a side elevational view.

FIG. 9C schematically illustrates the multi-well container positioning device of FIG. 9A from another side elevational view.

FIG. 9D schematically illustrates the multi-well container positioning device of FIG. 9A from a perspective view.

FIG. 9E schematically shows a perspective view of the multi-well container positioning device of FIG. 9A mounted on a translational mechanism.

FIG. 10A schematically shows an alignment member of a multi-well container positioning device from a detailed top view.

FIG. 10B schematically depicts the alignment member of FIG. 10A from a detailed side view.

FIG. 10C schematically shows the alignment member of FIG. 10A from a detailed bottom view.

FIG. 11A schematically shows an alignment member of a positioning device from a detailed top view.

FIG. 11B schematically depicts the alignment member of FIG. 11A from a detailed side view.

FIG. 11C schematically shows the alignment member of FIG. 11A from a detailed bottom view.

FIG. 12A schematically shows a pusher component from a detailed front view.

FIG. 12B schematically shows the pusher component of FIG. 12A from a detailed side view.

FIG. 12C schematically shows the pusher component of FIG. 12A from a detailed rear view.

FIG. 13A schematically shows a lever arm of a pusher from a detailed front view.

FIG. 13B schematically depicts the lever arm of FIG. 13A from a detailed rear view.

FIG. 13C schematically shows the lever arm of FIG. 13A from a detailed perspective view.

FIG. 14A schematically depicts a lever shaft of a pusher from a detailed front view.

FIG. 14B schematically illustrates the lever shaft of FIG. 14A from a detailed side view.

FIG. 14C schematically illustrates the lever shaft of FIG. 14A from a detailed top view.

FIG. 14D schematically shows the lever shaft of FIG. 14A from a detailed perspective view.

FIG. 15A schematically depicts a pin capture block of a pusher from a detailed top view.

FIG. 15B schematically shows the pin capture block of FIG. 15A from a detailed side view.

FIG. 15C schematically depicts the pin capture block of FIG. 15A from a detailed bottom view.

FIG. 16 schematically shows a nest for positioning multi-well containers from a perspective view according to one embodiment of the invention.

FIG. 17A schematically shows a perspective view of a multi-well container station according to one embodiment of the present invention.

FIG. 17B schematically depicts the multi-well container station of FIG. 17A from a top view.

FIG. 18A schematically shows a top view of a microtiter plate.

FIG. 18B schematically illustrates a bottom view of the microtiter plate shown in FIG. 18A.

FIG. 18C schematically depicts a cross-sectional view of the microtiter plate shown in FIG. 18A.

FIG. 19 is a diagram showing part placement on the underside of a container station according to one embodiment of the invention.

FIG. 20 is a block diagram showing electrical, vacuum, and air interconnections in a container station of a positioning device according to one embodiment of the invention.

FIG. 21 schematically shows a partial cross-sectional view of a container station according to one embodiment of the invention.

FIG. 22 schematically shows a partial side elevational view a piston and lever mechanism for a pusher according to one embodiment of the present invention.

FIG. 23 schematically illustrates a perspective view of a pusher lever according to one embodiment of the invention.

FIG. 24A schematically illustrates one embodiment of a multi-well container processing system from a perspective view.

FIG. 24B schematically depicts a detailed top perspective view of the fluid removal head and a dispense head from the system of FIG. 24A.

FIG. 24C schematically shows a detailed bottom perspective view of the fluid removal head and a dispense head from the system of FIG. 24A.

FIG. 25 schematically illustrates a representative system for removing fluids from multi-well containers in which various aspects of the present invention may be embodied.

FIGS. 26A through 26D are diagrammatic representations of an x-axis pusher and a y-axis pusher positioning a microtiter plate.

### DETAILED DESCRIPTION

I. Definitions

Before describing the present invention in detail, it is to be understood that this invention is not limited to particular embodiments. It is also to be understood that the terminology used herein is for the purpose of describing particular embodiments only, and is not intended to be limiting. Units, prefixes, and symbols are denoted in the forms suggested by the International System of Units (SI), unless specified otherwise. Numeric ranges are inclusive of the numbers defining the range. Further, unless defined otherwise, all technical and scientific terms used herein have the same meaning as commonly understood by one of ordinary skill in the art to which the invention pertains. The terms defined below, and grammatical variants thereof, are more fully defined by reference to the specification in its entirety.

The term “adjacent wells” refers to wells of a multi-well container that are disposed next to one another (e.g., side-by-side, diagonally across from one another, etc.) in the container without another well being disposed between them. In certain embodiments, for example, a set of adjacent wells can include 2, 3, or 4 wells.

The term “align” refers to a positioning or state of adjustment of two or more items in relation to each other. In certain embodiments, for example, the orifices of a vacuum plate align with one or more regions of a bottom surface of a multi-well container that are disposed between adjacent wells of the container.

The term “bottom” refers to the lowest point, level, surface, or part of an object, device, system, or component thereof, when oriented for typical designed or intended operational use, such as positioning multi-well containers, and/or the like.

The term “coaxial” or “concentric” refers a state in which two or more objects, or components thereof, have coincident centers or axes. In certain embodiments when a multi-well container is positioned on a vacuum plate of a multi-well container positioning device in a selected position, for example, the centers of vacuum plate orifices and the midpoints of corresponding regions of a bottom surface of a multi-well container that are disposed between adjacent wells have coincident axes. To further illustrate, multi-well container positioning devices optionally include multiple chambers having common centers, e.g., in the form of concentric circles, concentric squares, concentric rectangles, or other concentric shapes.

A chamber of a multi-well container positioning device “communicates” with an orifice of the device when pressure can be applied through the orifice via the chamber.

The term “compensate” in the context of multi-well container positioning refers to offsetting or counteracting defects, warping, irregularities, imperfections, and/or other structural variations in multi-well containers. In some embodiments, for example, negative pressure is applied to draw a bottom surface of a multi-well container toward vacuum plate orifices to counteract structural variations of the container.

The term “conforms” refers to an act or process of giving a object, or a portion thereof, the same or similar shape, outline, or contour as at least a portion of another object, even if only transiently. In some embodiments, for example, the shape of at least a portion of the bottom surface of a multi-well container is altered, at least temporarily, to assume the contour of at least a portion of a vacuum plate of a multi-well container positioning device under an applied pressure. In embodiments where vacuum plates are flat, at least a portion of the bottom surface of a multi-well container is typically flattened to conform to this contour of the vacuum plates when pressure is applied to the container.

The term “contour” refers to an outline or shape that at least a portion of the perimeter of an item forms. To illustrate, exemplary contours of at least portions of vacuum plates optionally include, e.g., regular n-sided polygons, irregular n-sided polygons, triangles, squares, rectangles, trapezoids, circles, ovals, portions thereof, or the like. In some embodiments, the contour of a vacuum plate is substantially flat.

The term “retain” in the context of multi-well container positioning refers holding a multi-well container in a selected position at least transiently. For example, a selected position can include a position in which defects, warping, irregularities, imperfections, and/or other structural variations of the multi-well container are compensated for.

The term “substantially” refers to an approximation. In certain embodiments, for example, an orifice is disposed through a vacuum plate such that the orifice at least approximately aligns with a region of a bottom surface of a multi-well container that is disposed between adjacent wells when the container is positioned on the vacuum plate in a selected position. To further illustrate, an applied negative pressure typically at least transiently changes the shape of the bottom surface of a multi-well container such that it at least approximately conforms to a contour of the vacuum plate of the multi-well container positioning devices described herein.

The term “top” refers to the highest point, level, surface, or part of an object, device, system, or component thereof, when oriented for typical designed or intended operational use, such as positioning multi-well containers, and/or the like.

The term “translational axes” refers to three linear axes (i.e., X-, Y-, and Z-axes) in a three-dimensional rectangular coordinate system. The “X-axis” is substantially parallel to a horizontal plane and approximately perpendicular to both the Y- and Z-axes. The “Y-axis” is substantially parallel to a horizontal plane and approximately perpendicular to both the X- and Z-axes. The “Z-axis” is substantially parallel to a vertical plane and approximately perpendicular to both the X- and Y-axes.

II. Introduction

The invention provides positioning devices for accurately and precisely positioning and retaining multi-well containers on vacuum plates of container stations in desired positions, even when those containers have structural irregularities or imperfections. The container stations of these devices are structured to position essentially any multi-well container, including high density containers having over 1000 wells. Once disposed in desired or selected positions on these vacuum plates, multi-well containers are typically subjected to further processing. For example, the systems of the invention that include the positioning devices described herein support a broad range of synthesis and assay formats, including screens for compounds with desired properties. The systems of the invention are typically highly automated with minimal user intervention for repeated usage at high throughput in, e.g., laboratory and industrial settings. The devices, systems, software, and methods described herein are also readily adaptable such that a variety of samples and sample assays can be accommodated to acquire information about the samples.

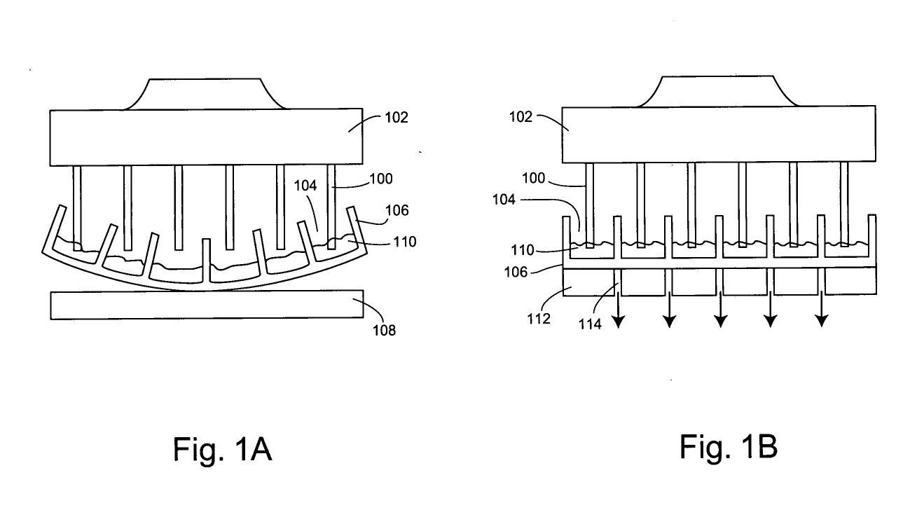

To further illustrate, multi-well containers, in certain instances, have lower or bottom surface imperfections that can interfere with the stable and accurate positioning of the containers for processing. Such imperfections can include, e.g., warping, height variations, and other structural irregularities. For example, the bottom surface of a multi-well container, such as a microtiter plate, may bow at least slightly so that, e.g., the center portion of the container extends below the perimeter edge of the container. Imperfections such as these can lead, e.g., to positioning instability as only the center portions of these containers generally contact positioning supports unless the imperfections or irregularities are somehow taken into account. Moreover, uncompensated imperfections such as these also tend to create well-depth variations that may lead to error, e.g., when material handling or washing devices access the wells during a given processing application. For example, certain multi-well container washing systems include material removal heads having tips that enter the wells of multi-well containers to remove fluids and/or other materials during operation. Multi-well container warping can impact the proper functioning of these systems. More specifically, the amount of residual fluid volume left by a material removal head of such a system is regulated, at least in part, by the distance between the end of a given tip and the bottom of the particular well being accessed by the tip. The tips of a material removal head can generally be aligned to close tolerances (e.g., +/−0.025 mm). The problem arises from warped (e.g., bowed concave up, etc.) multi-well containers. In certain cases, the difference in height from the center well to the outer well in a multi-well container can vary by, e.g., up to about 0.40 mm. This can produce a volume difference of approximately 1 μL in some containers in the residual fluid volume of a center well compared to the residual volume of fluid in a well towards the perimeter of the multi-well container following fluid removal by a material removal head. In certain applications, the target residual volume is about 1.0+/−0.1 μL. Thus, unless a warped multi-well container is flattened out, the target residual volume for each well typically cannot be achieved. This problem is schematically illustrated in FIG. 1A, which shows tips 100 of material removal head 102 disposed in wells 104 of warped multi-well container 106, which is supported on non-vacuum plate 108. As shown, the distances between the ends of tips 100 in wells 104 and the bottoms of wells 104 varies, with some tips 100 contacting fluid 110 in wells 104, while other tips 100 do not contact fluid 110 in wells 104. Multi-well container washing systems are also described in, e.g., U.S. Provisional Patent Application No. 60/598,994, entitled “MULTI-WELL CONTAINER PROCESSING SYSTEMS, SYSTEM COMPONENTS, AND RELATED METHODS,” filed Aug. 4, 2004 by Micklash II et al. and International Publication No. WO 2004/091746, entitled “MATERIAL REMOVAL AND DISPENSING DEVICES, SYSTEMS, AND METHODS,” filed Apr. 7, 2004 by Micklash II et al., which are both incorporated by reference.

Accordingly, in some embodiments, the container stations described herein include alignment members for aligning multi-well containers along x- and y-axes, and vacuum plates having orifices through which negative pressure is applied to uniformly position the wells of the containers relative to one another along the z-axis, e.g., to compensate for structural imperfections or irregularities that may be present in the containers. More specifically, negative pressure is generally applied at a level that is sufficient to cause the shapes of at least portions of at least the bottom surfaces of the multi-well containers to substantially conform to the contours of the vacuum plates. In some embodiments, for example, vacuum plate contours are substantially flat or level such that the multi-well containers flatten under the applied pressure, thereby reducing the structural imperfections or irregularities that may be present in the multi-well containers. As mentioned, among the advantages of positioning the wells of multi-well containers at substantially the same position along their z-axes is the reduction of the likelihood of system damage and other processing errors that might otherwise result if material handling devices were presented, e.g., with well-depth variations and unstably positioned multi-well containers during processing applications. To further illustrate, FIG. 1B schematically shows tips 100 of material removal head 102 entering wells 104 of warped multi-well container 106, which is supported on vacuum plate 112. As shown, orifices 114 are disposed through vacuum plate 112. Under an applied negative pressure (represented by the downward pointing arrows), multi-well container 106 substantially flattens to conform to the contour of the surface of vacuum plate 112. As a result, the distances between the ends of tips 100 in wells 104 and the bottoms of wells 104 are substantially uniform such that residual volumes remaining in wells 104 of multi-well container 106 following fluid removal with material removal head 102 will are also substantially uniform.

Typically, the orifices of the vacuum plates are configured to substantially align with portions of multi-well containers that have the greatest structural integrity or strength (e.g., tensile strength, etc.). To illustrate, the orifices of a vacuum plate are typically configured to substantially align or otherwise coincide with regions of the bottom surface of a multi-well container that are disposed between adjacent wells (e.g., regions that form the walls between the adjacent wells, etc.). These orifice configurations tend to minimize, if not eliminate, dimpling effects and other structural distortions that may otherwise occur under applied pressure if the orifices were aligned with the wells themselves. Dimpling most commonly occurs in multi-well containers that have thin bottom walls, such as certain clear bottom microtiter plates, etc. As with other structural irregularities, these pressure induced distortions can also lead to multi-well container processing errors.

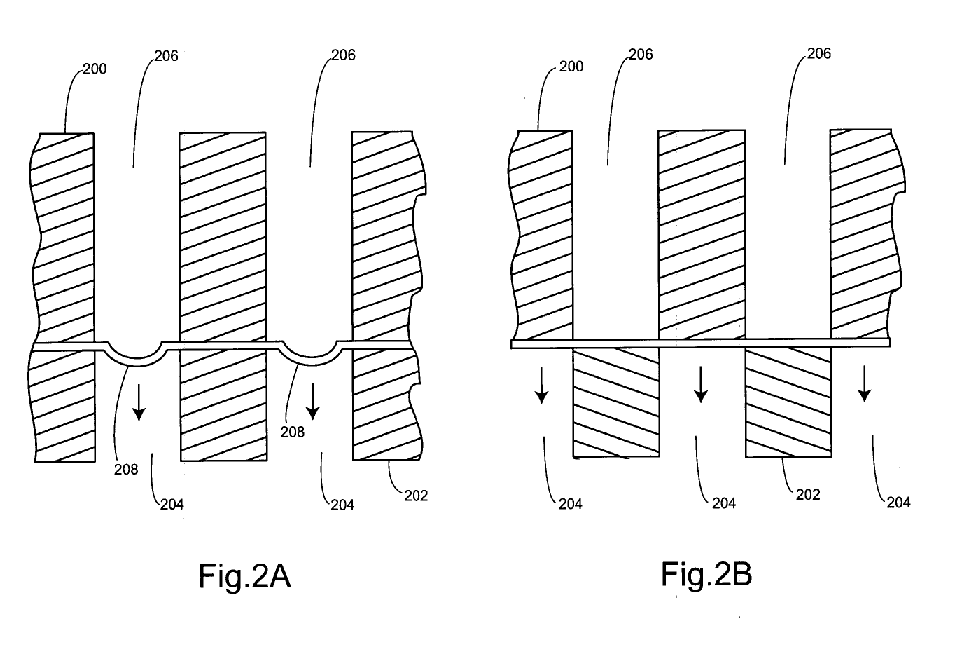

To further illustrate, dimpling effects are schematically shown in FIG. 2A, which depicts a cross-section through a portion of multi-well container 200 and a portion of vacuum plate 202 in which orifices 204 of vacuum plate 202 are substantially aligned with regions of the bottom surface of multi-well container 200 that underlie wells 206 of multi-well container 200. Under an applied negative pressure (represented by the downward pointing arrows), the bottoms of wells 206 of multi-well container 200 are pulled downward and form dimples 208. In contrast, FIG. 2B schematically shows a cross-section through a portion of multi-well container 200 and a portion of vacuum plate 202 in which orifices 204 of vacuum plate 202 are substantially aligned with regions of the bottom surface of multi-well container 200 that are disposed between adjacent wells 206 of multi-well container 200. As shown, when negative pressure is applied (represented by the downward pointing arrows) to orifices 204, this dimpling effect is not observed.

The invention also provides multi-well container positioning devices that include multi-well container stations having vacuum plates with multiple orifices disposed therethrough and multiple chambers that communicate with different offices. During operation, negative pressure can be applied in the chambers in a selected sequence such that different regions of multi-well containers are incrementally positioned and retained (e.g., in selected stages, etc.) on the vacuum plates, e.g., to compensate for structural imperfections that may be present in the containers. Optionally, negative pressure can be applied the chambers substantially simultaneously to effect container positioning and retention on the vacuum plates.

In addition to multi-well container positioning devices, the invention further provides automated systems that include these positioning devices and related computer program products. The systems of the invention include material handling devices for dispensing and/or removing materials from selected wells of multi-well containers positioned on the positioning devices of the systems. The systems of the invention also typically include various additional components for performing many different types of chemical syntheses, compound screening, and other processes. The invention also provides methods of positioning multi-well containers on the devices described herein for additional processing, including material transfer and assay detection.

While the present invention will be described with reference to a few specific embodiments, the description is illustrative of the invention and is not to be construed as limiting the invention. Various modifications to the present invention can be made to the exemplary embodiments by those skilled in the art without departing from the true scope of the invention as defined by the appended claims. It is noted here that for a better understanding, like components are designated by like reference letters and/or numerals throughout the various figures, unless the context indicates otherwise.

III. Multi-Well Container Positioning Devices and Systems

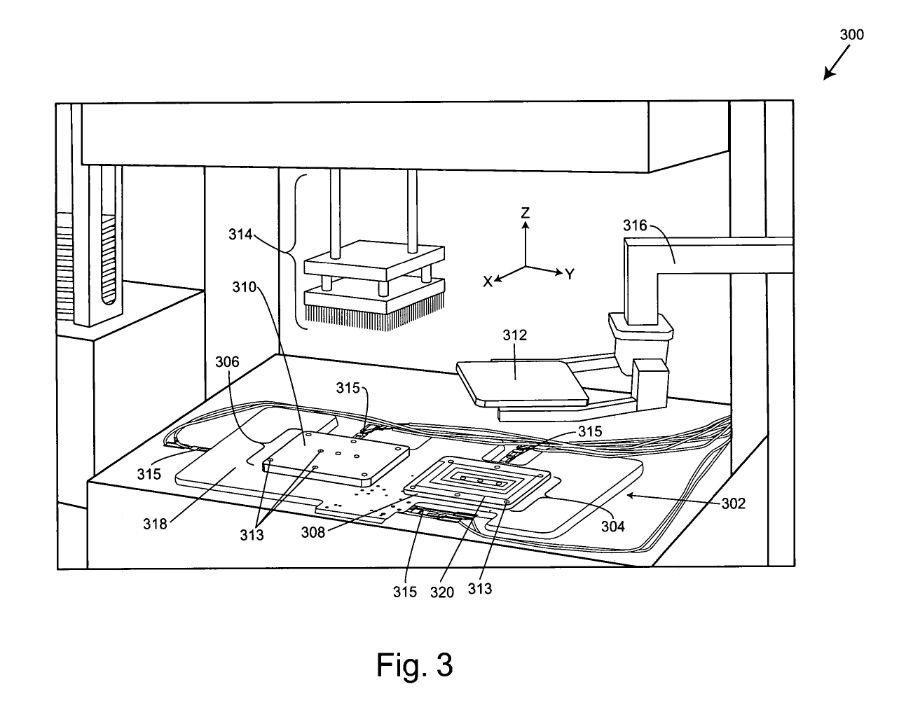

As an overview, FIG. 3 schematically shows representative system 300 from a perspective view according to one embodiment of the invention. As shown, system 300 includes multi-well container positioning device 302, which includes support structure 318. Support structure 318 includes multi-well container stations 304 and 306 that include vacuum plates 308 and 310, respectively, which are each structured to position a multi-well container, such as multi-well container 312 relative to material handling device 314 (shown as a fluid transfer device) and robotic translocation device 316. As shown, vacuum plates 308 and 310 each include orifices 313 that communicate with chambers (not within view) disposed below vacuum plates 308 and 310. The chambers communicate with negative pressure sources (not within view), such as vacuum sources that effect negative pressure at orifices 313 to draw bottom surfaces of multi-well containers toward vacuum plates 308 and 310 to compensate for structural defects or irregularities of the multi-well containers, e.g., that otherwise produce non-uniformity in the wells of the containers along z-axes. Vacuum plate 308 includes heating element 320 that adjustably regulates temperature in the wells of a multi-well container when the container is positioned on vacuum plate 308. As also shown, multi-well container positioning device 302 also includes pushers 315 coupled to support structure 318. Pushers 315 are configured to push multi-well containers into contact with alignment members (not shown) when the containers are placed on vacuum plates 308 and 310, e.g., to align the containers along x- and/or y-axes. Optionally, container station 304 is utilized to position a multi-well plate containing sample compounds and container station 306 is utilized to position an assay multi-well plate into which compounds are transferred from the sample compound multi-well plate positioned in container station 304 using fluid transfer device 314. Robotic translocation device 316 is used to translocate multi-well plates to and/or from container stations 304 and 306. Each of these system components is described in greater detail below.

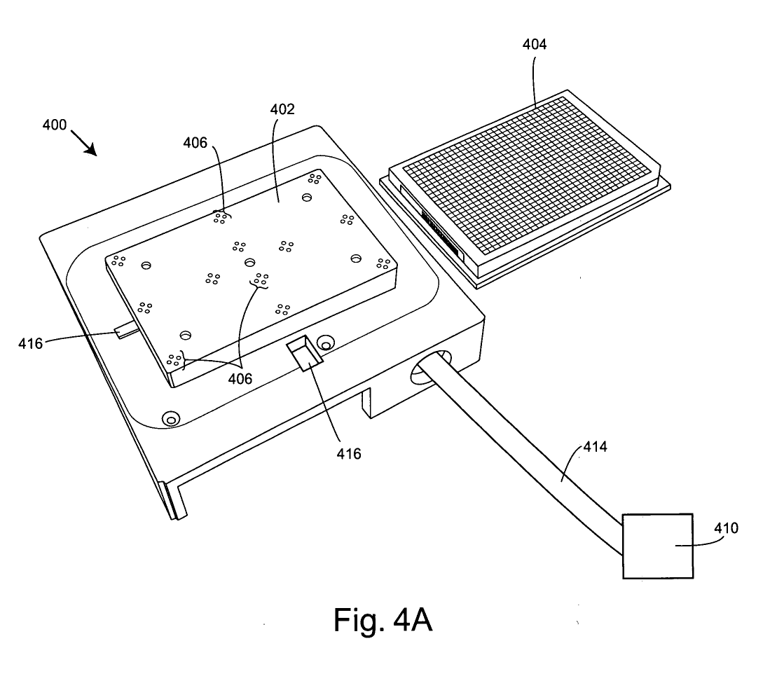

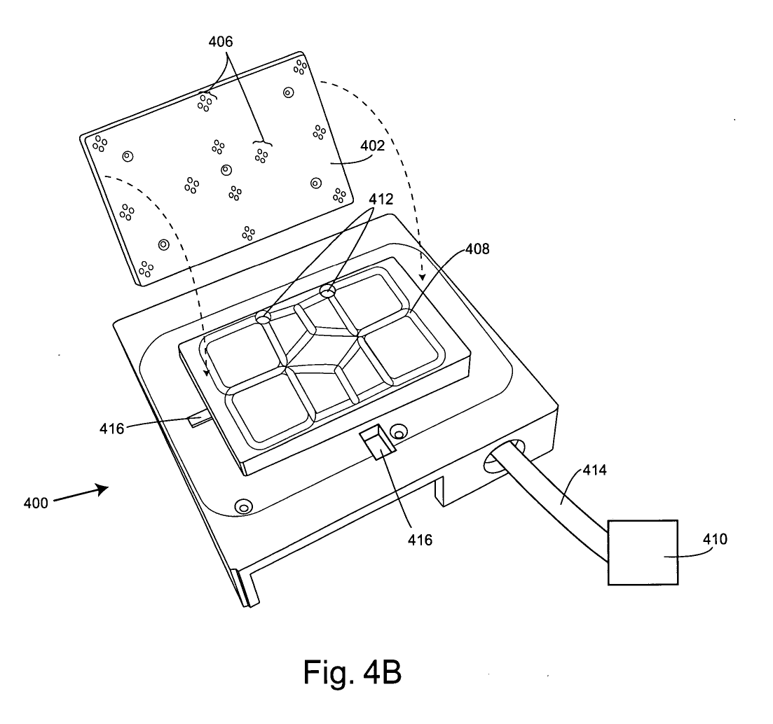

To further illustrate aspects of the present invention, FIG. 4A schematically depicts multi-well container station 400 according to one embodiment of the invention. As shown, multi-well container station 400 includes vacuum plate 402 that is structured to support multi-well container 404 (shown as a 1536-well microtiter plate). Vacuum plate 402 includes orifices 406, which are configured to substantially align with regions of the bottom surface of multi-well container 404 that are disposed between adjacent wells multi-well container 404 when multi-well container 404 is positioned on vacuum plate 402 in a selected position. Orifices 406 are configured in this manner so as to align with regions of multi-well container 404 that have higher structural integrity that regions disposed directly under the wells. This minimizes, if not eliminates, dimpling effects or other structural distortions from occurring on the bottom surfaces of well when pressure is applied to multi-well container 404 through orifices 406, which may otherwise damage multi-well container 404 and/or introduce error into a given application. Distortions, such as dimpling effects are discussed further above.

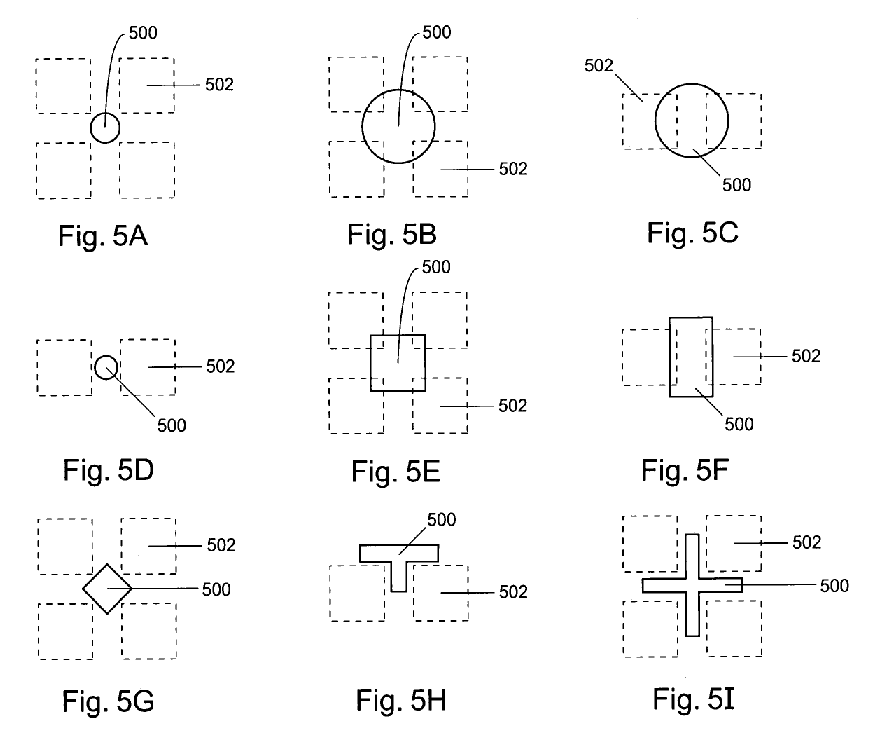

Essentially any orifice configuration (e.g., orifice positioning in a given vacuum plate, orifice cross-sectional shape, orifice cross-sectional dimension, orifice cross-sectional area, and/or the like) is optionally utilized so long as the orifices substantially align with regions of multi-well containers that have greater strength than those disposed directly under the wells, e.g., so that structural imperfections (e.g., warping, etc.) of multi-well containers can be compensated for at the same time pressure-induced distortions (e.g., dimpling, etc.) are also at least minimized during container positioning processes. For example, vacuum plates are typically structured to support, position, and retain (e.g., compensate for structural imperfections, etc.) multi-well containers that include, e.g., 6, 12, 24, 48, 96, 192, 384, 768, 1536, 3456, 9600, or more wells. Orifice cross-sectional area generally needs to be large enough so that the negative pressure flow rate can create a large enough pressure difference to draw multi-well containers towards the vacuum plates. In some embodiments, however, vacuum plates include one or more orifices that do substantially align with the regions disposed directly under the wells of a particular multi-well container. Orifices generally have cross-sectional shapes selected from, e.g., regular n-sided polygons, irregular n-sided polygons, tees, crosses, triangles, squares, rounded squares, rectangles, rounded rectangles, trapezoids, circles, ovals, and the like. To illustrate, FIGS. 5A-I schematically depict various representative orifices 500 having some of these cross-sectional shapes, which orifices 500 are each substantially aligned with regions of bottom surfaces of multi-well containers (only portions within view) that are disposed between adjacent wells 502 of the multi-well containers. Vacuum plates that include one or more orifices having cross-sectional shapes that differ from one another are also optionally utilized in certain embodiments. Other exemplary orifice configurations are illustrated and/or otherwise described herein. Orifices are generally machined, molded, or otherwise formed in the vacuum plates of the multi-well container positioning devices describe herein. Device fabrication is described further below.

At the same time dimpling effects are minimized in the wells of multi-well container 404, the pressure applied through orifices 406 substantially conforms the shape of the bottom surface that underlies the well area of multi-well container 404 to the contour of vacuum plate 402, which in this embodiment is depicted as being substantially flat. Accordingly, under sufficient applied pressure the shape of the bottom surface that underlies the well area of multi-well container 404 flattens, thus reducing or eliminating imperfections or irregularities (e.g., warping, height variations, etc.) that may be present in the structure (at least underlying the well area) of multi-well container 404.

The multi-well container positioning devices described herein also include chambers, manifolds, or other structures that communicate with the orifices of vacuum plates such that pressure sources can apply pressure through the orifices. To illustrate, FIG. 4B schematically shows a partially exploded perspective view of multi-well container station 400. As shown, multi-well container station 400 includes a portion of chamber 408 machined into multi-well container station 400. Complete chamber 408 is formed upon attaching vacuum plate 402 to the remaining portion of multi-well container station 400 shown in FIG. 4B, e.g., by bolting, adhering, welding, bonding, or otherwise attaching the two components to one another. Chamber 408 communicates with negative pressure source 410 (e.g., a vacuum pump, a centrifugal blower, and the like) via holes 412 and tube 414. As shown in FIG. 4B, multi-well container station 400 includes a single chamber. In other embodiments, multi-well container stations include multiple chambers. In some of these embodiments, for example, multi-well container stations include, e.g., 2, 3, 4, 5, 6, 7, 8, 9, 10, or more chambers. Optionally, these multiple chambers communicate with the same negative pressure source or with different negative pressure sources. In certain embodiments, a chamber simply comprises an operable connection between a negative pressure source and an orifice, such as a tube or other conduit that connects a negative pressure source and an orifice to one another. Other exemplary chamber formats are illustrated and/or described further below.

As also shown in FIGS. 4 A and B, multi-well container station 400 also includes apertures 416, which are structured to receive pushers (not shown). Pushers, which are described further below, are configured to push multi-well containers into contact with alignment members (not shown) to align multi-well container along an x-axis and/or y-axis in selection positions.

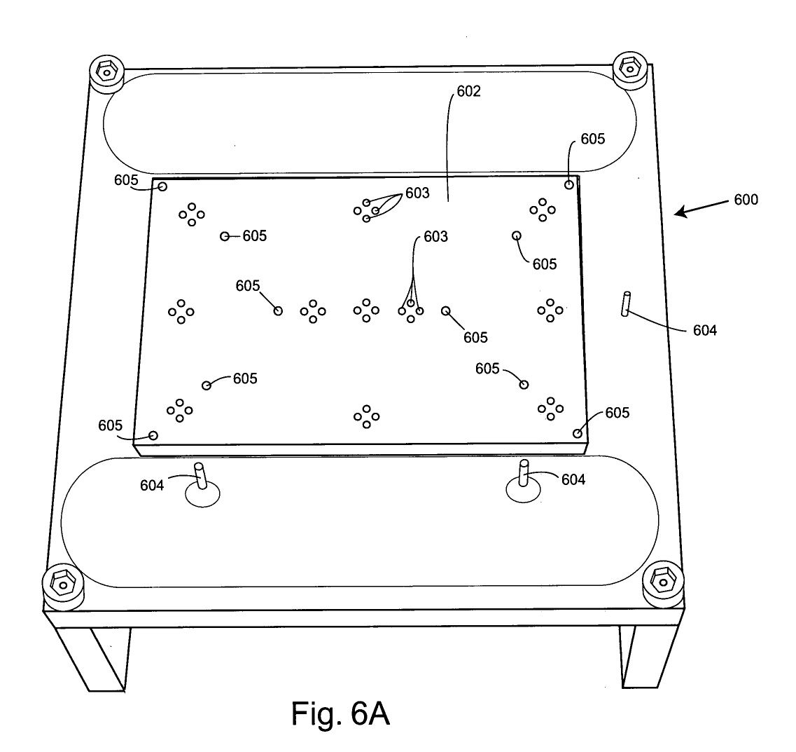

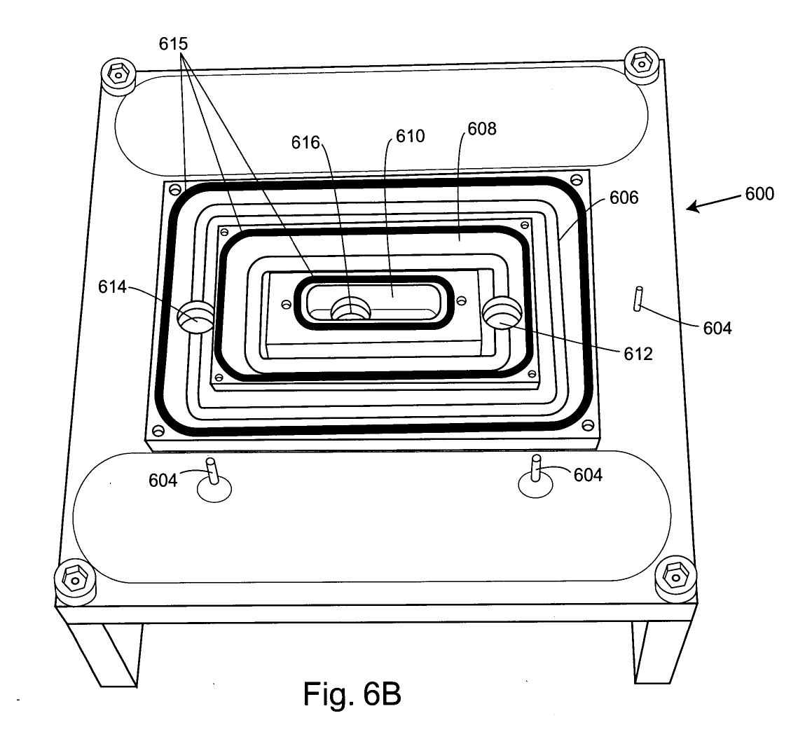

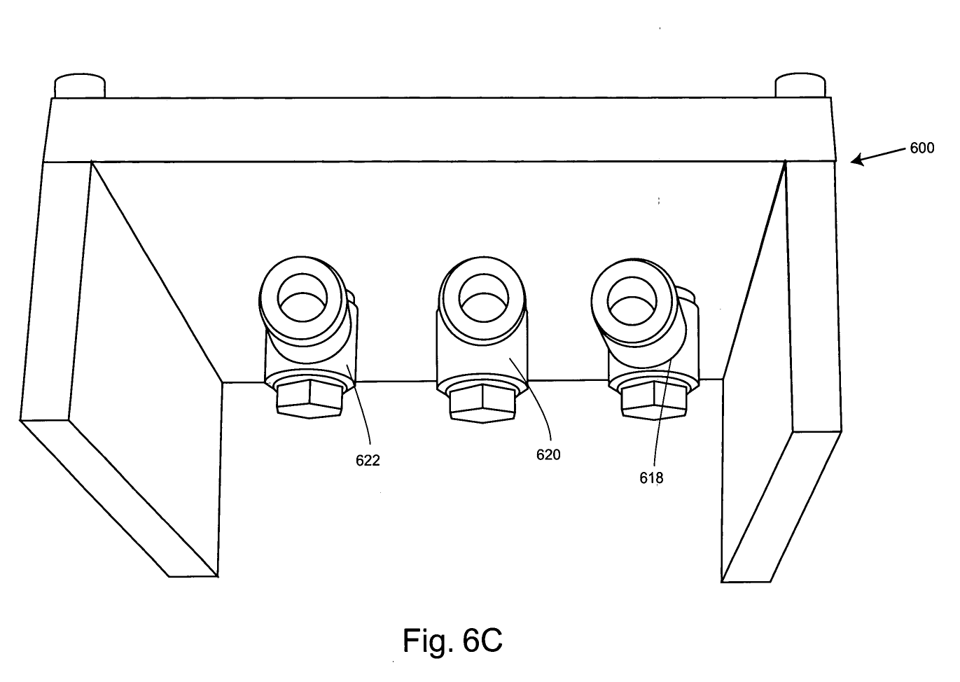

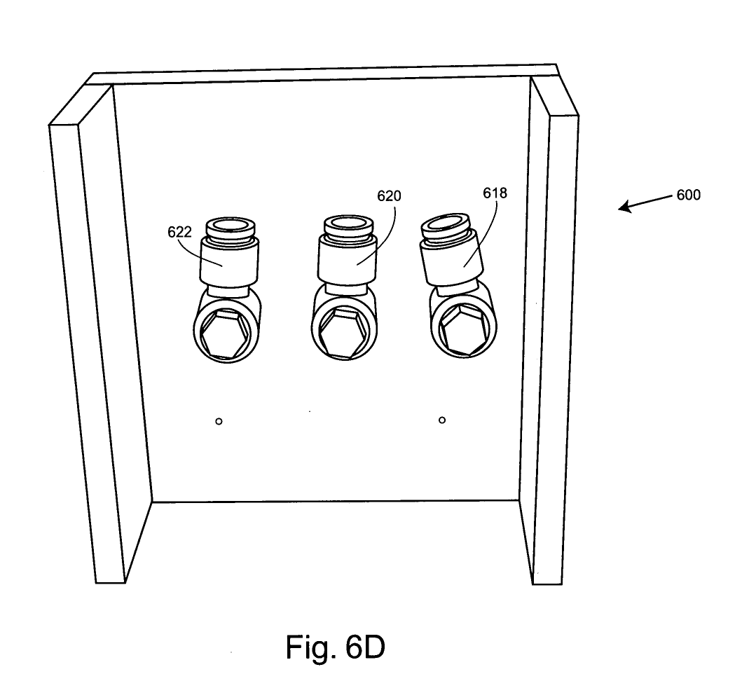

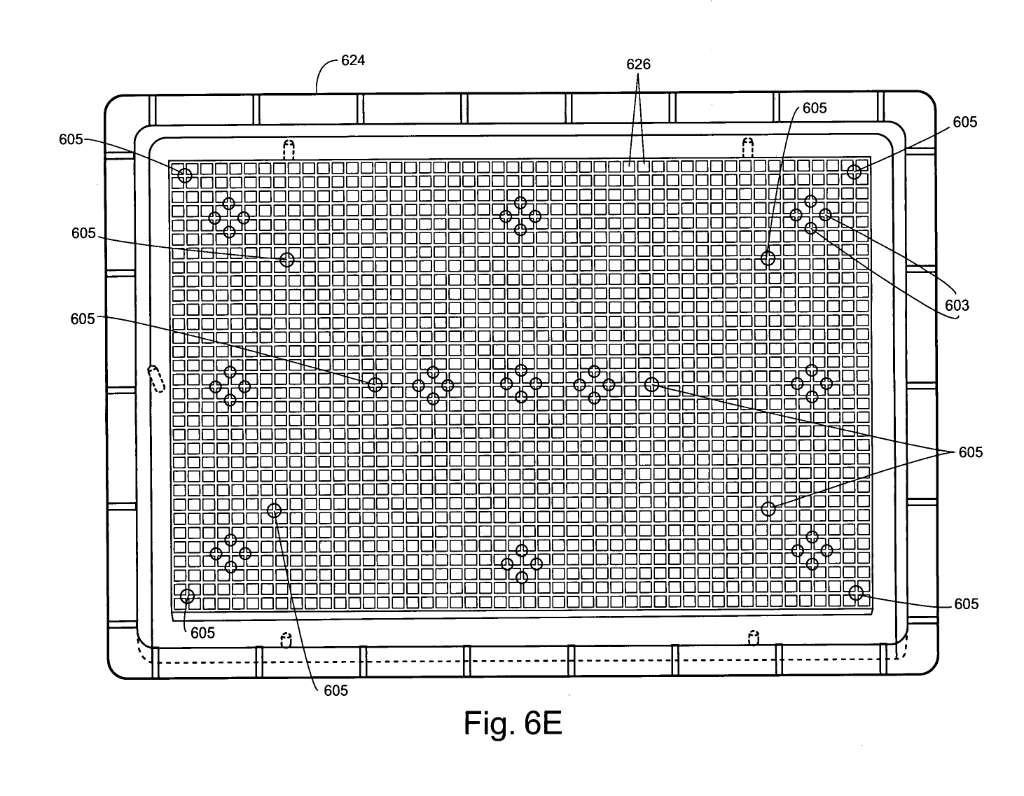

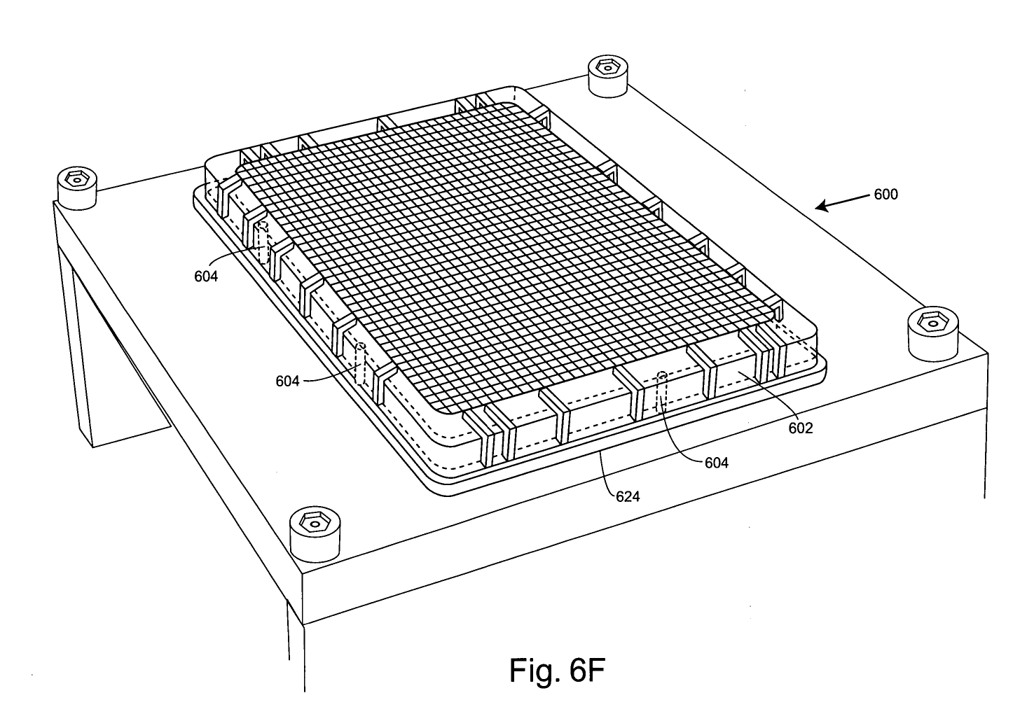

Now referring to FIG. 6A, which schematically illustrates multi-well container station 600 from a perspective view according to another embodiment of the invention. As shown, vacuum plate 602 includes orifices 603 through which negative pressure is applied to position and retain multi-well containers on multi-well container station 600. Vacuum plate 602 also includes holes 605, which are structured to receive bolts, screws, or other fasteners to attach vacuum plate 602 to the remaining portion of multi-well container station 600. As also shown, multi-well container station 600 includes alignment members 604 disposed proximal to vacuum plate 602. As mentioned above, alignment members 604 are used to align multi-well containers along at least two of the three translational axes. Alignment members are also described further below.

To further illustrate, FIG. 6B schematically shows multi-well container station 600 without vacuum plate 602 from a perspective view. As shown, multi-well container station 600 includes portions of chambers 606, 608, and 610, which are concentrically disposed in multi-well container station 600. Gaskets 615 are also included to effectively seal chambers 606, 608, and 610 from one another in the assembled device. As also shown, chambers 606, 608, and 610 include apertures 612, 614, and 616, respectively. During operation, negative pressure is applied to chambers 606, 608, and 610 via apertures 612, 614, and 616. FIGS. 6 C and D schematically depict multi-well container station 600 from bottom perspective views. As shown, multi-well container station 600 includes ports 618, 620, and 622, which communicate with apertures 612, 614, and 616, respectively. Although not shown, one or more negative pressure sources typically communicate with ports 618, 620, and 622 via tubing or other conduits so that pressure can be applied through orifices 603 of vacuum plate 602. In certain embodiments, these conduits include one or more valves that are used to regulate pressure applied by the negative pressure sources.

FIGS. 6 E and F schematically illustrate multi-well container 624 positioned on vacuum plate 602 of multi-well container station 600 from top and perspective views, respectively. As shown, each orifice 603 of vacuum plate 602 substantially aligns with regions of the bottom surface disposed under a well area of multi-well container 624 that are disposed between four adjacent wells 626.

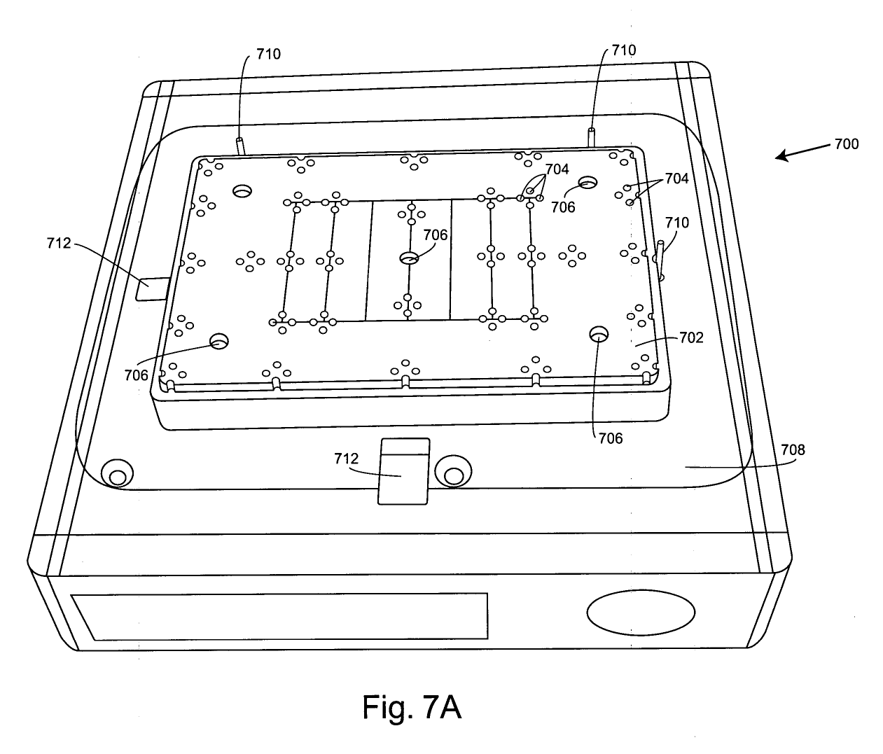

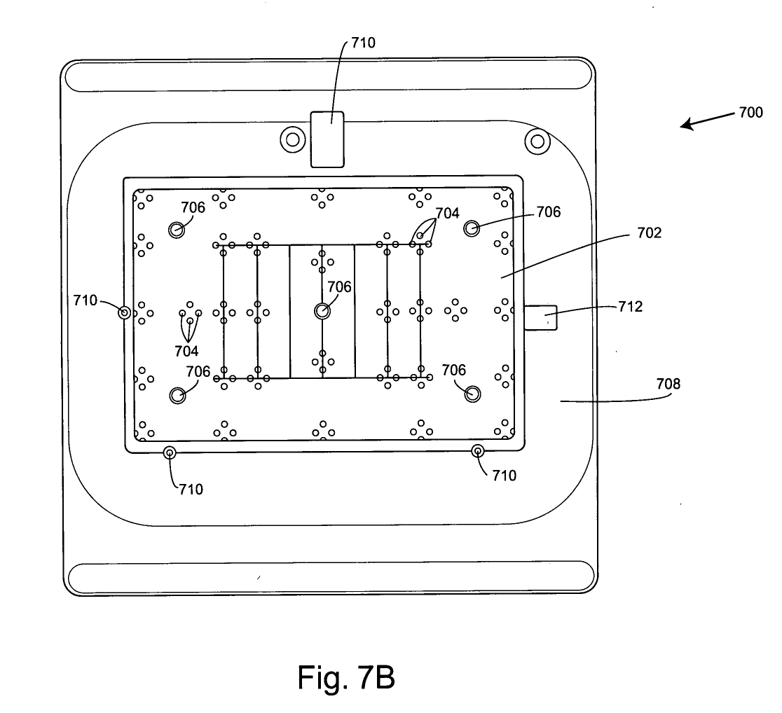

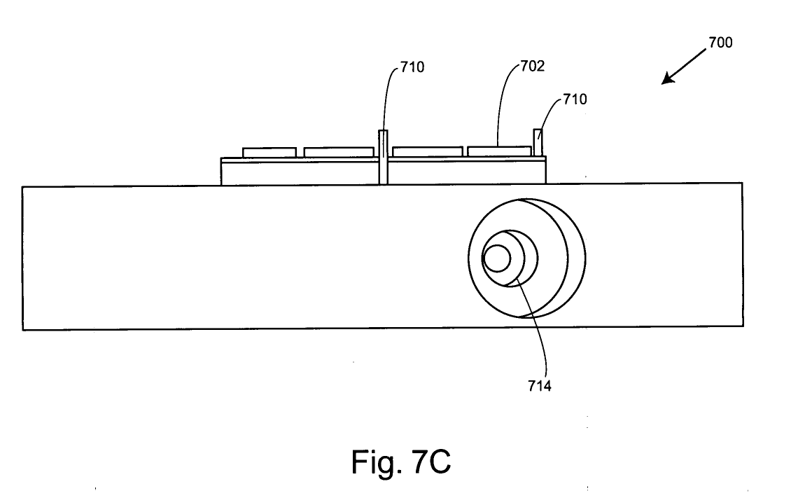

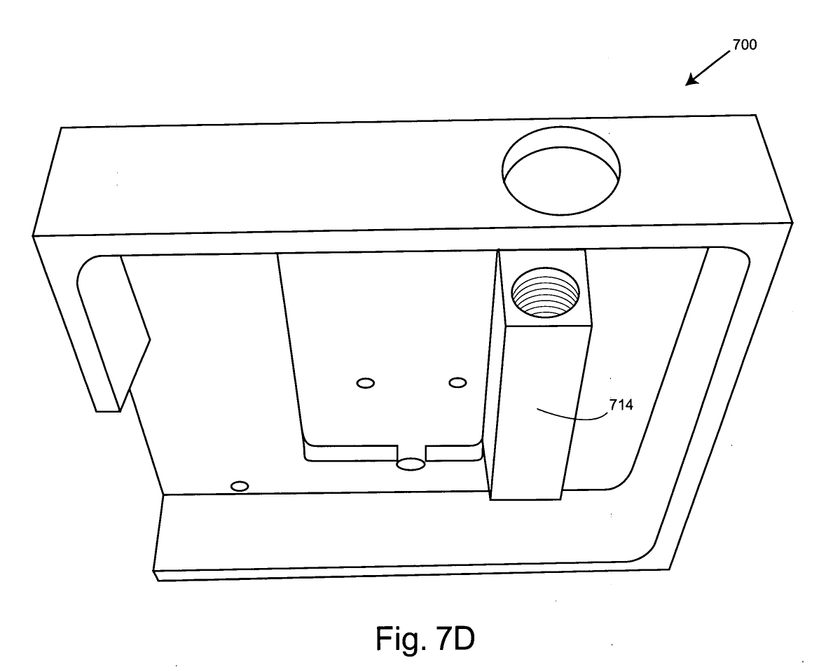

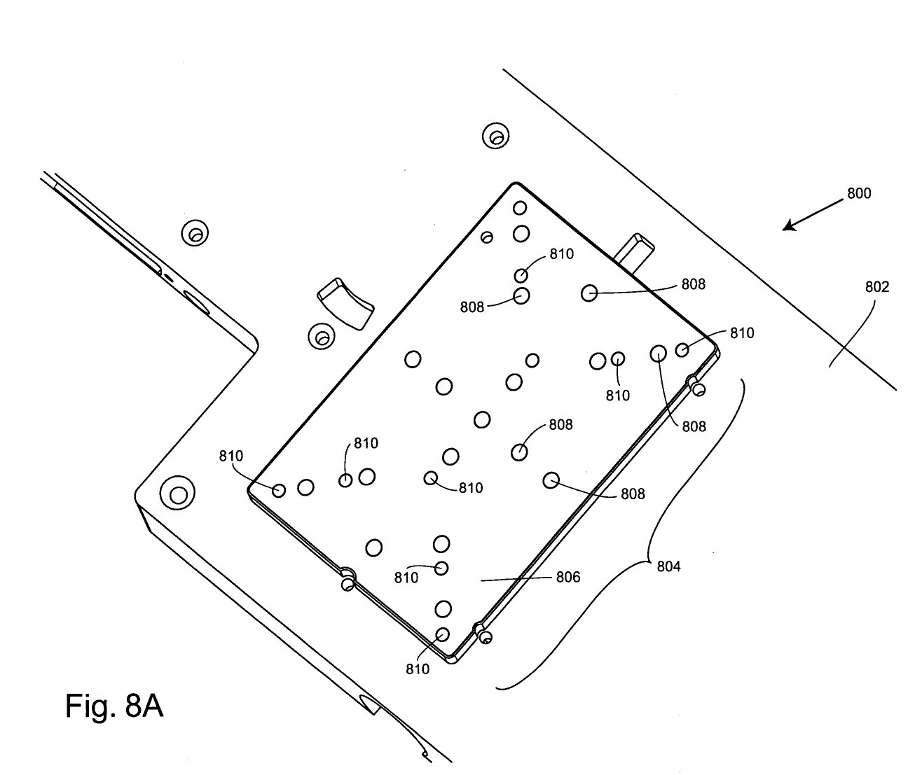

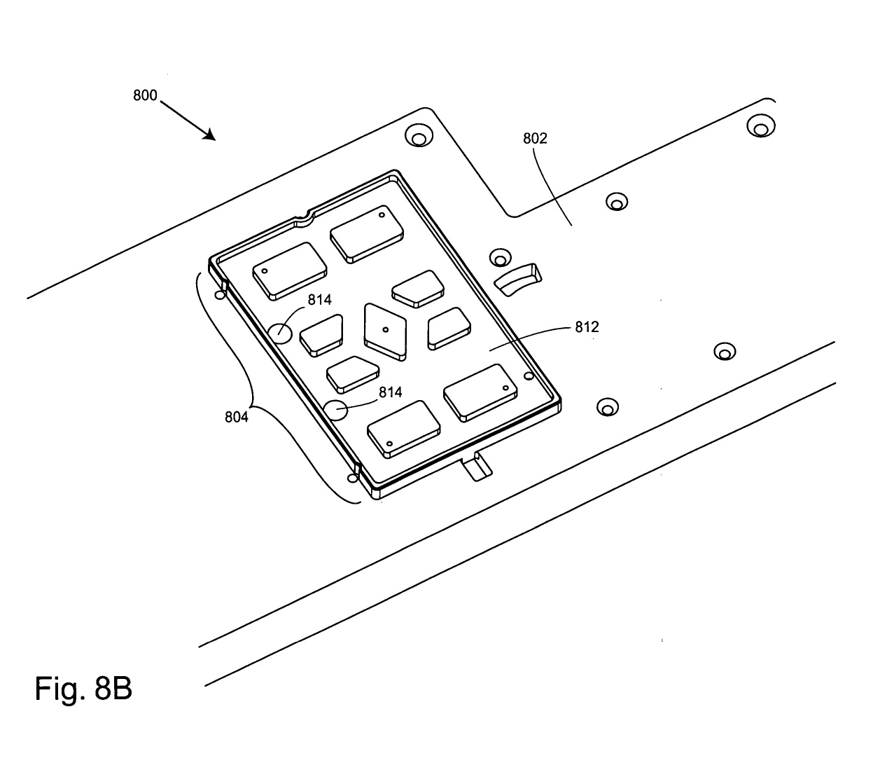

Other exemplary multi-well container positioning device component embodiments are provided in FIGS. 7 and 8. In particular, FIGS. 7 A and B schematically show multi-well container station 700 from perspective and top views, respectively, according to one embodiment of the invention. As shown, multi-well container station 700 includes vacuum plate 702 having orifices 704 and holes 706 disposed through vacuum plate 702. Holes 706 are structured to receive fasteners (e.g., bolts, screws, rivets, etc.) for attaching vacuum plate 702 to support structure 708. As also shown, multi-well container station 700 includes alignment members 710 and apertures 712, which are structured to receive pushers. To further illustrate, FIGS. 7 C and D schematically depict multi-well container station 700 from side and perspective views, respectively. As shown, multi-well container station 700 includes port 714, which communicates with orifices 704 of vacuum plate 702 via a chamber (not within view). A tube or other conduit is typically connected to port 714 and a negative pressure source.

FIG. 8A schematically depicts multi-well container positioning device 800 from a top perspective view according to one embodiment of the invention. As shown, multi-well container positioning device 800 includes support structure 802 having multi-well container station 804. Multi-well container station 804 includes vacuum plate 806 attached to support structure 802. Support structure 802 includes orifices 808 for retaining multi-well containers as described herein, and holes 810 for attaching vacuum plate 806 to support structure 802. In addition, FIG. 8B schematically illustrates multi-well container positioning device 800 without vacuum plate 806 from a top perspective view to expose a portion of chamber 812. To further illustrate, FIG. 8C schematically shows multi-well container positioning device 800 from a bottom perspective view. As shown, chamber 812 communicates with port 816 via apertures 814. A negative pressure source is typically operably connected to port 816.

In some embodiments, the positioning devices of the invention include multiple multi-well container stations, e.g., to position multiple containers for material transfer when performing a given assay. Optionally, at least two of the multi-well container stations are tiered, that is, disposed at different levels. In systems that include robotic translation devices, tiered multi-well container stations have the advantage of allowing the robotic device to access and handle (e.g., grasp and re-locate) a first multi-well container positioned at one tiered container station without contacting a second multi-well container positioned at another tiered multi-well container station, e.g., at least along planes that are substantially parallel to top surfaces (i.e., surfaces in which wells are disposed) of the multi-well containers. In addition, the container stations of the invention are typically configured such that the wells of multi-well containers positioned in two or more of the multi-well container stations are accessible (e.g., along an axis that is substantially perpendicular to top surfaces of the containers) substantially simultaneously (e.g., using a fluid handling device or the like). Multi-well container positioning devices having tiered multi-well container stations are also described in, e.g., International Application No. PCT/US04/025079, entitled “MULTI-WELL CONTAINER POSITIONING DEVICES AND RELATED SYSTEMS AND METHODS,” filed Aug. 3, 2004 by Evans, which is incorporated by reference. In addition, aspects of multi-well container positioning are also described in, e.g., International Publication No. WO 01/96880, entitled “AUTOMATED PRECISION OBJECT HOLDER,” filed Jun. 15, 2001 by Mainquist et al., and International Application No. PCT/US04/25170, entitled “NON-PRESSURE BASED FLUID TRANSFER IN ASSAY DETECTION SYSTEMS AND RELATED METHODS,” filed Aug. 3, 2004 by Evans et al., which are both incorporated by reference.

The multi-well container stations of the positioning devices of the invention also optionally include heating elements (e.g., external to or integral with the multi-well container stations) to regulate temperature in multi-well containers, e.g., when an assay is performed using the device. Suitable heating elements that can be adapted for use in the devices and systems of the invention are generally known in the art and are readily available from various commercial sources. Heating elements are typically operably connected to a power source and/or controllers, which control operation of the elements. An exemplary heating element is schematically illustrated in FIG. 3, which shows heating element 320 disposed on vacuum plate 308 of multi-well container station 304.

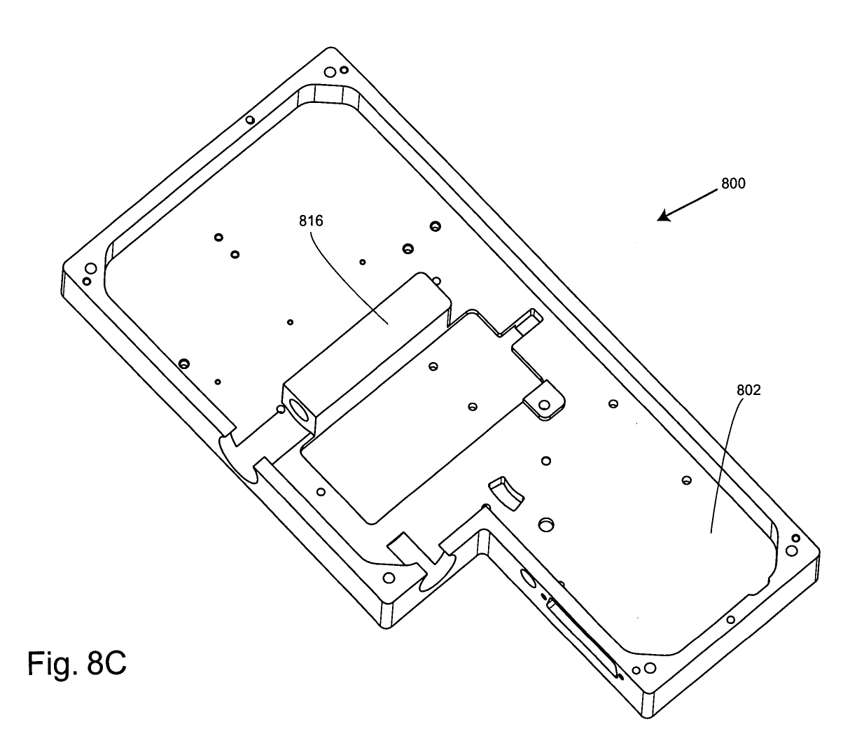

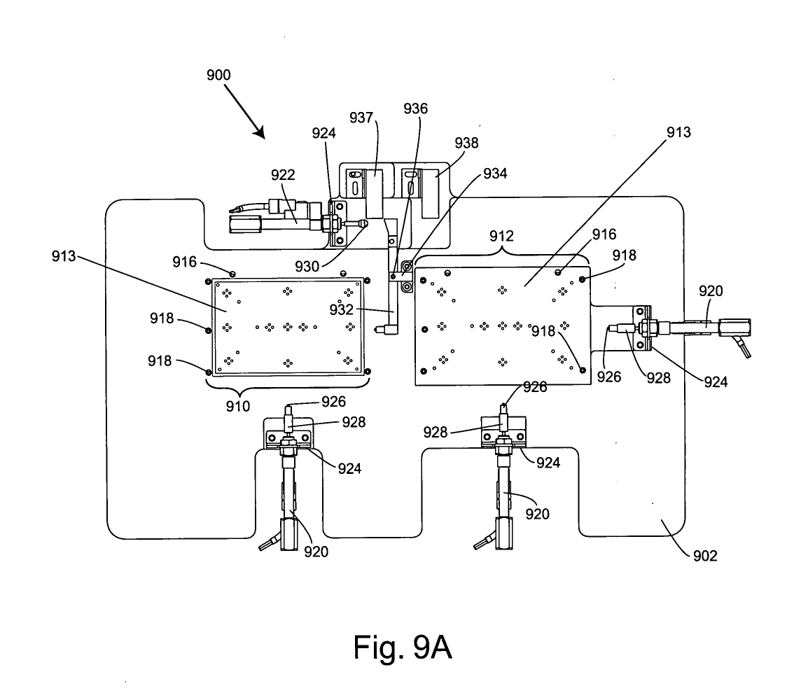

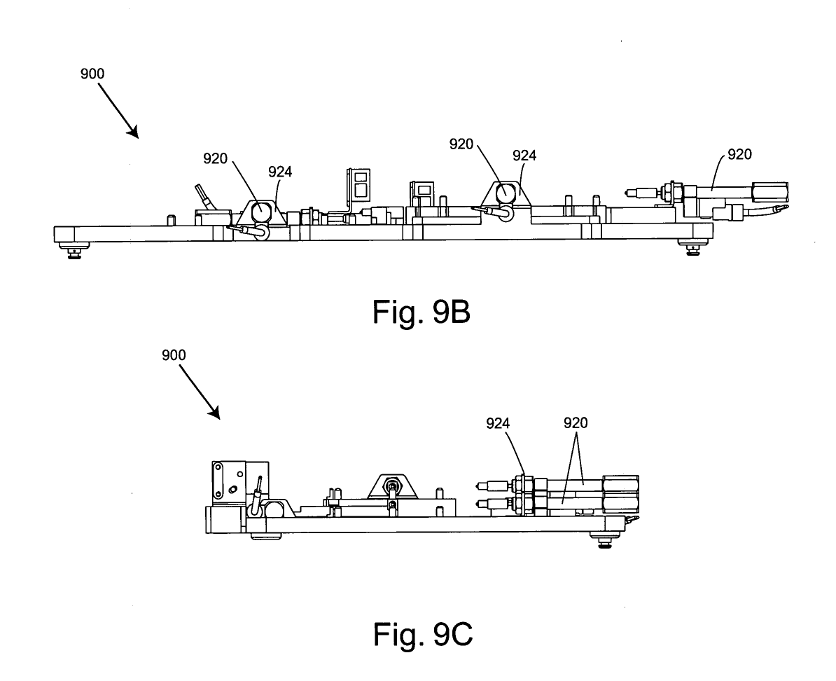

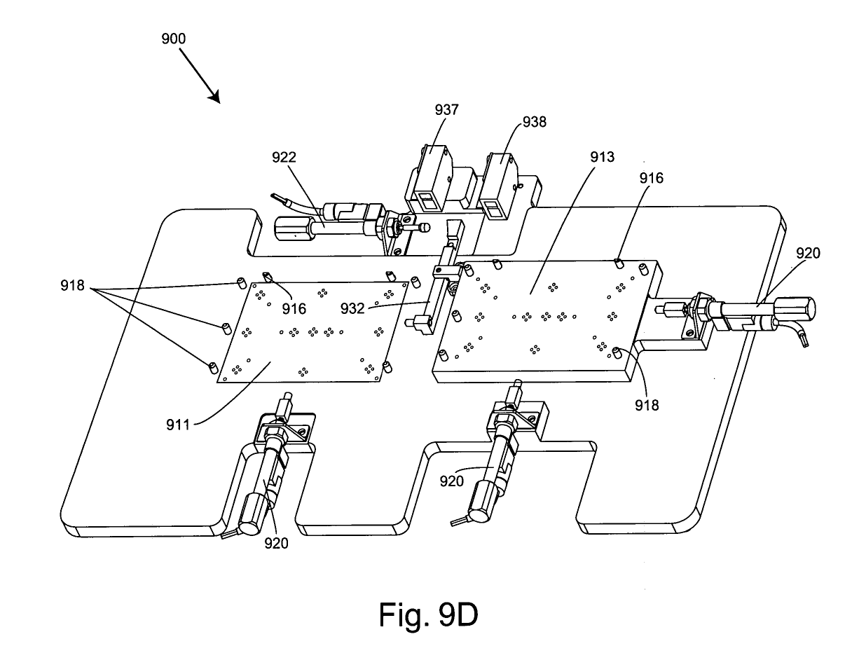

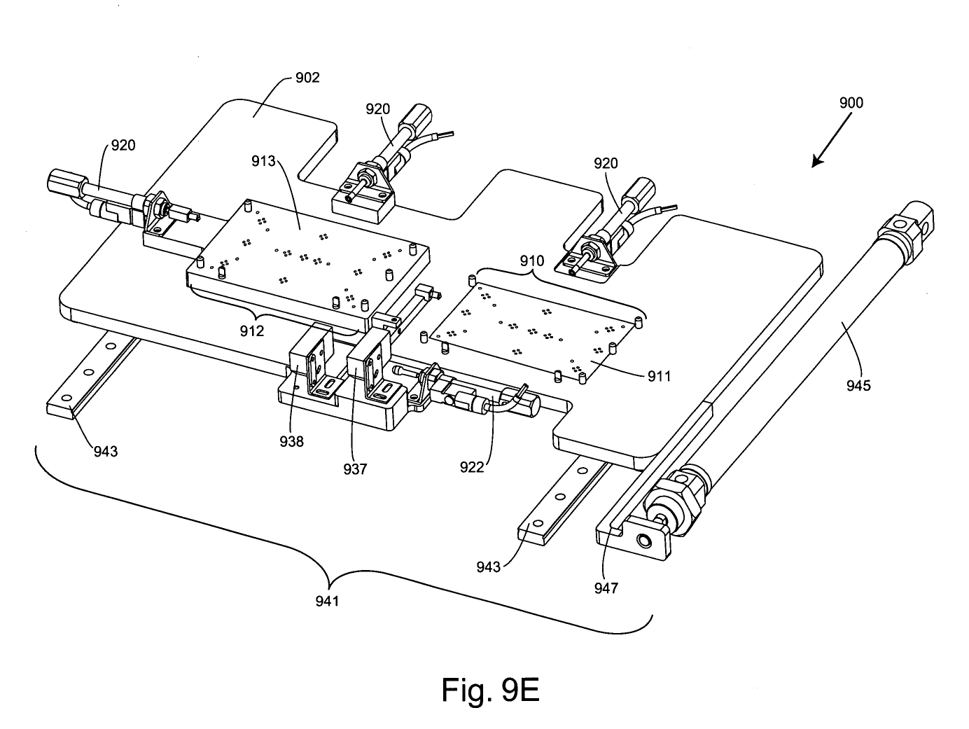

The positioning devices of the invention generally include alignment members that are positioned to contact surfaces of multi-well containers (e.g., inner walls of alignment receiving areas, etc.) when the multi-well containers are positioned in the multi-well container stations such that the multi-well containers align with the material handling devices and/or other system components. Alignment receiving areas of multi-well containers are described in greater detail below. In addition, these positioning devices also typically include pushers that push the multi-well containers into contact with the alignment members when the multi-well containers are positioned in the multi-well container stations. Embodiments of these aspects of the multi-well container positioning devices of the invention are illustrated in FIGS. 9A-E. More specifically, FIG. 9A schematically shows multi-well container positioning device 900 from a top view. As shown, multi-well container positioning device 900 includes alignment members 916 (shown as trimmed face locating pins) and alignment members 918 (shown as locating pins having curved surfaces), which align with inner surfaces of standard multi-well plates positioned in multi-well container stations 910 and 912, which include vacuum plates 911 and 913, respectively. When more than two alignment members are included substantially along the same line, such as alignment members 918 of multi-well container station 910, at least one of those members is typically slightly offset from the others in the line as only three points of contact will determine the position of a multi-well container (e.g., two alignment members 918 and one alignment member 916). As also shown, multi-well container positioning device 900 further includes pneumatically-driven pushers 920 and 922 (e.g., air cylinders or the like), which effect container positioning relative to alignment members 916 and 918. Pushers 920 and 922 are mounted to support structure 902 via pusher mounts 924 and are operably connected to pressure sources (not shown). Pushers 920 include spring plungers 926 and plunger posts 928. Pusher 922 includes knob 930 that contacts lever arm 932 to push lever arm 932 into contact with a container. Lever arm 932 is mounted to support structure 902 via pin capture block 934 and lever shaft 936, which form a pivotal coupling. As also shown in FIG. 9A, multi-well container positioning device 900 also includes position sensors or laser assemblies 937 and 938 for detecting the presence of multi-well containers in multi-well container stations 910 and 912, respectively. FIGS. 9 B and C schematically show positioning device 900 from side elevational views. In addition, FIG. 9D schematically illustrates positioning device 900 from a perspective view.

To further illustrate aspects of the invention, FIG. 9E schematically shows a perspective view of multi-well container positioning device 900 of FIG. 9A mounted on translational mechanism 941. When positioning devices are included in systems such as automated system 300 schematically shown in FIG. 3, translational mechanisms are optionally included such that multi-well container positioning devices can be translocated along at least one translational axis, e.g., to facilitate access to multi-well containers positioned in the multi-well container positioning devices by a user, a robotic translocation device, and/or the like. In the embodiment shown, translational mechanism 941 includes rails or tracks 943 on which positioning device 900 is mounted and along which positioning device 900 slides. In addition, actuator 945 (e.g., an air cylinder, motor, etc.) is operably connected to support structure 902 of multi-well container positioning device 900 via bracket 947. Actuator 945, which is generally operably connected to a controller, effects translocation of multi-well container positioning device 900 along tracks 943. Additional translational mechanisms are described below.

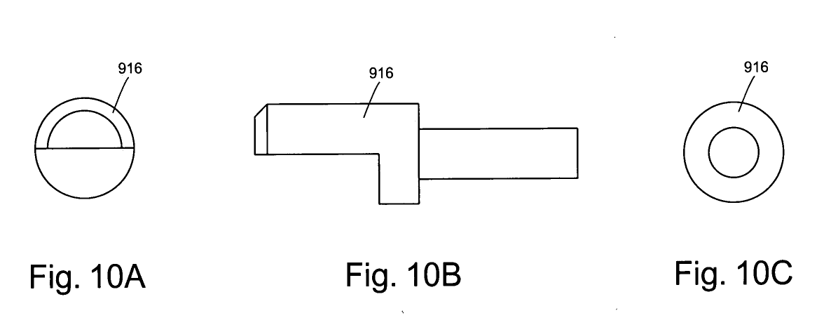

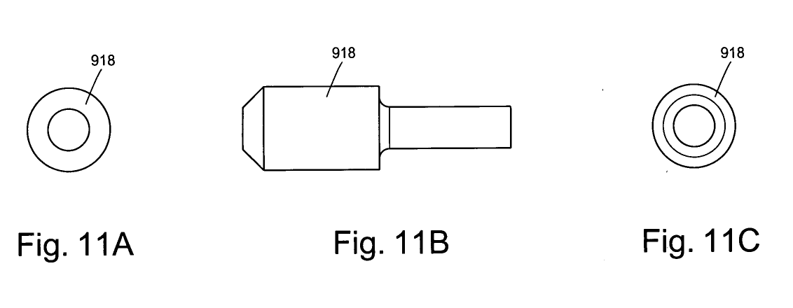

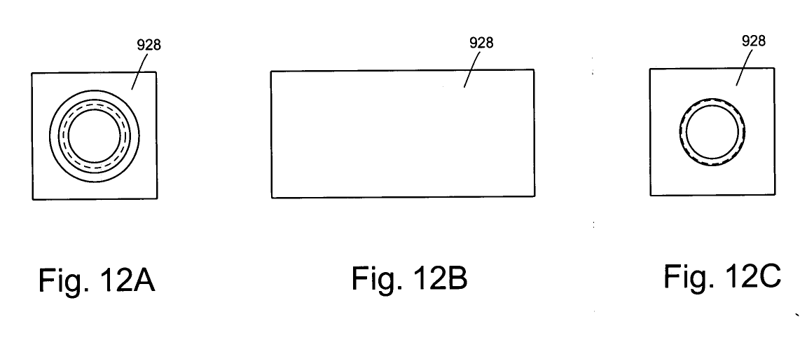

FIG. 10A schematically shows alignment member 916 of multi-well container positioning device 900 from a detailed top view, while FIGS. 10 B and C schematically show alignment member 916 from detailed side and bottom views, respectively. Further, FIG. 11A schematically shows alignment member 918 of multi-well container positioning device 900 from a detailed top view, whereas FIGS. 11 B and C schematically depict alignment member 918 from detailed side and bottom views, respectively. Additionally, FIGS. 12A-C schematically show plunger post 928 from detailed front, side, and rear views, respectively. Although other materials are optionally used, these components are typically fabricated from aluminum and optionally finished with a black anodization.

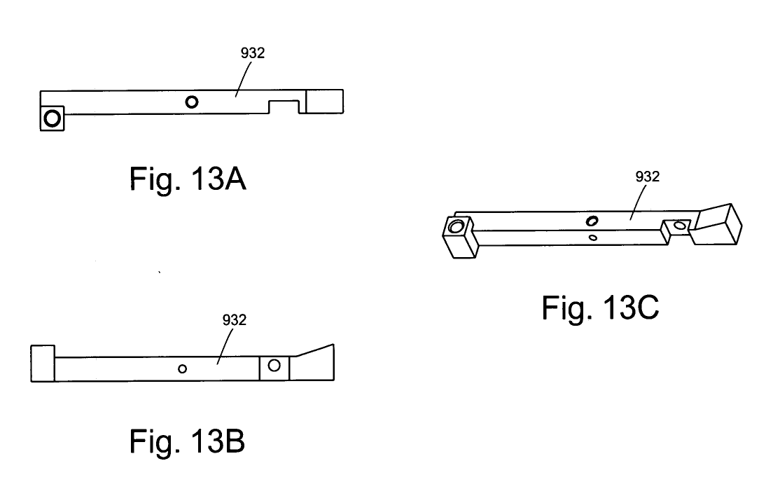

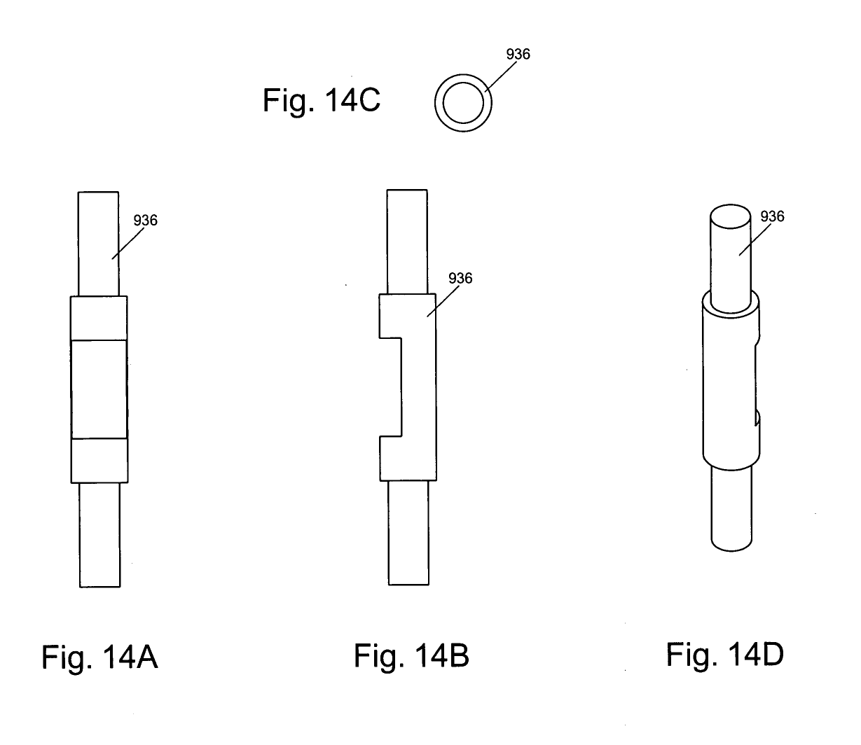

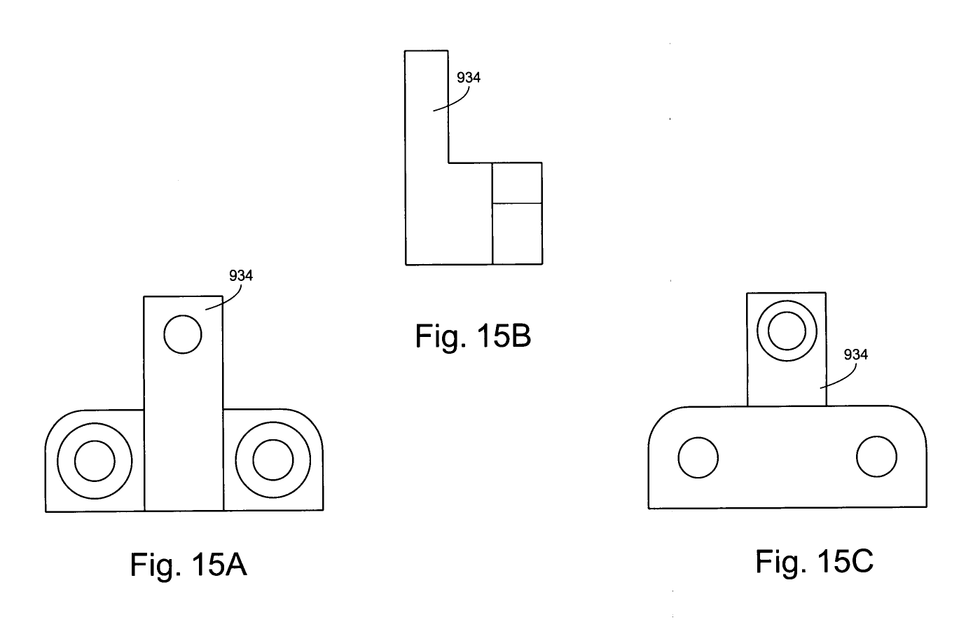

FIGS. 13-15 schematically show detailed views of various pusher components related to pusher 922. In particular, FIGS. 13A-C schematically show lever arm 932 from detailed front, rear, and perspective views, respectively. FIGS. 14A-D schematically depict lever shaft 936 from detailed front, side, top, and perspective views, respectively. In addition, FIGS. 15A-C schematically show pin capture block 934 from detailed top, side, and bottom views, respectively. As with other components of the container positioning devices of the invention, while other materials are optionally utilized, these components are also typically fabricated from aluminum and optionally finished with a black anodization. Pushers can be moved by means known to those of skill in the art. For example, air cylinders, springs, pistons, elastic members, electromagnets or other magnets, gear drives, and the like, or combinations thereof, are suitable for moving the pushers so as to move multi-well container containers into a selected position.

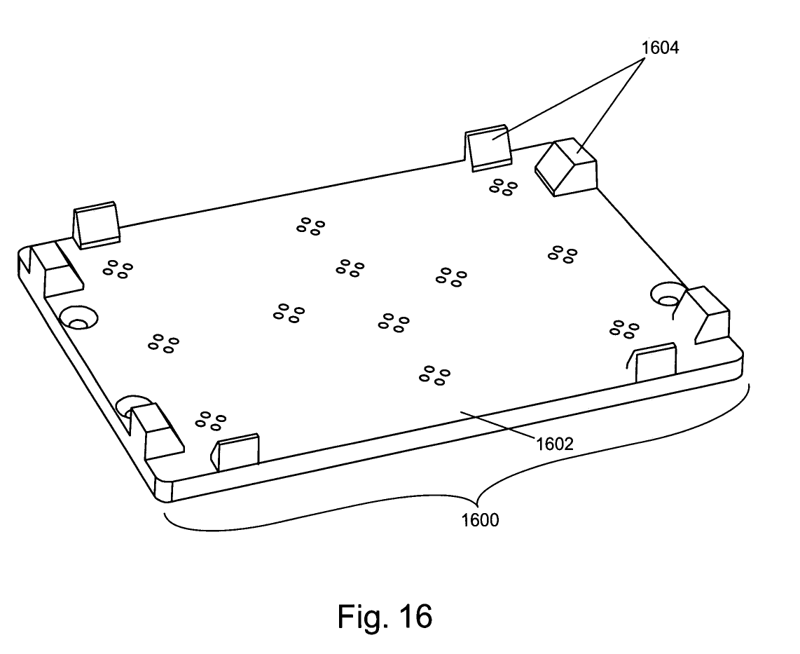

The vacuum plates of the multi-well container positioning devices of the present invention also include other embodiments. For example, FIG. 16 schematically shows nest 1600 that includes vacuum plate 1602 from a perspective view. A multi-well container can be placed into nest 1600 to position and retain the multi-well container relative to other system components. Nest 1600 is typically precisely fabricated (e.g., machined, molded, etc.) such that multi-well containers fit tightly (i.e., substantially without room for lateral movement, etc.) into nest 1600. Component fabrication is described further below. As shown, nest 1600 includes multiple alignment members 1604 that include angled surfaces that are configured to direct a multi-well container into nest 1600, when the multi-well container is placed into nest 1600. Although not shown, nests and other vacuum plate embodiments are optionally fabricated to rotate, e.g., about the centers of multi-well containers positioned in those components so that multi-well container positions can be adjusted to align with, e.g., material handling devices, robotic translocation devices, and the like. This eliminates the need to include a corresponding rotational adjustment in these other system components. However, in some embodiments, these other rotational adjustments are also included for additional control over the alignment of the various system components. Nests with rotational couplings also described in, e.g., International Application No. PCT/US04/025079, entitled “MULTI-WELL CONTAINER POSITIONING DEVICES AND RELATED SYSTEMS AND METHODS,” filed Aug. 3, 2004 by Evans, which is incorporated by reference.

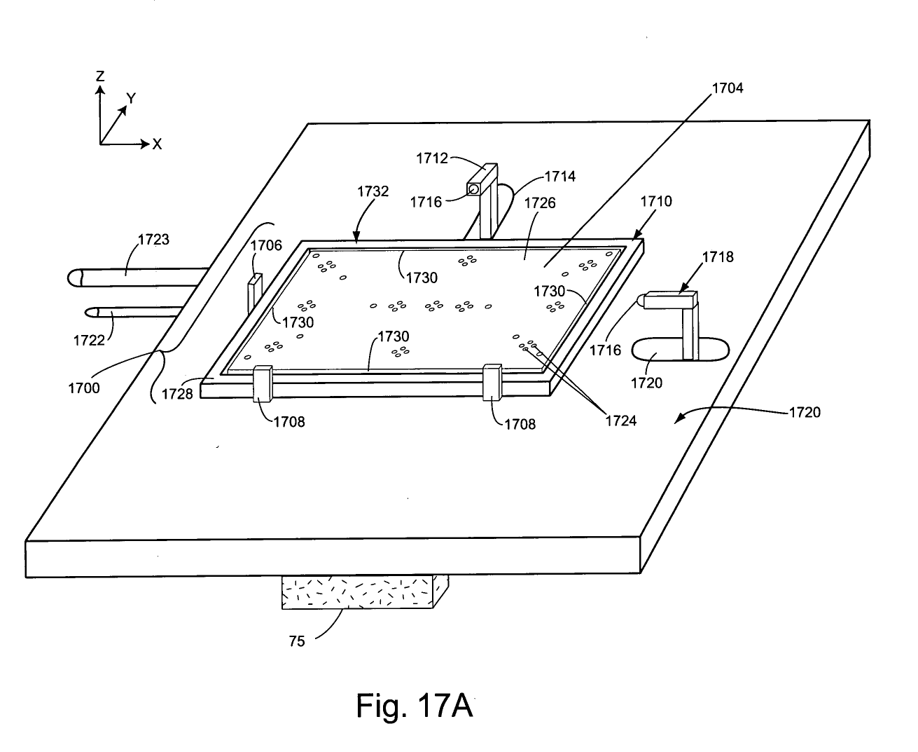

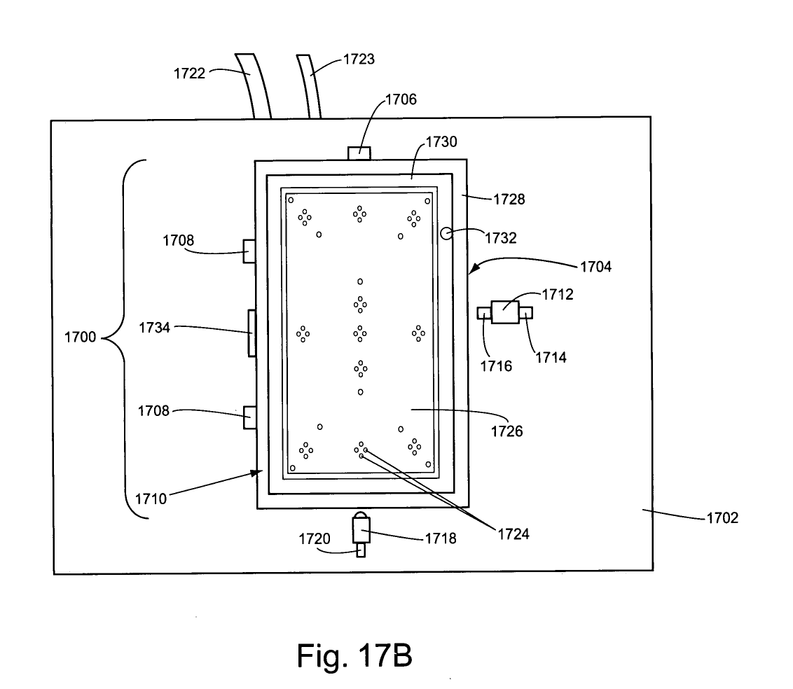

For positioning along two different axes, the positioning devices of the invention generally have one or more alignment members (also referred to above) positioned to receive each of the two axes of a multi-well container. For example, FIGS. 17 A and B show one embodiment of multi-well container station 1700 in accordance with the present invention. As shown, multi-well container station 1700 is disposed on support structure 1702 of a positioning device (only a portion is shown). Support structure 1702 supports vacuum plate 1704. Protrusions 1706 and 1708 function as alignment members. The illustrated embodiment of multi-well container station 1700 has two y-axis protrusions 1708 and one x-axis protrusion 1706 extending from support structure 1702. Accordingly, y-axis protrusions 1708 and x-axis protrusion 1706 are fixedly positioned relative to the vacuum plate 1704, which holds or “locks” the multi-well container in position once it has been positioned as described herein. Y-axis locating protrusions 1708 are constructed to cooperate with a y-axis surface of a multi-well container (e.g., an y-axis wall of a microtiter plate), while x-axis protrusion 1706 is constructed to cooperate with an x-axis surface of the container (e.g., an x-axis wall of a microtiter plate).

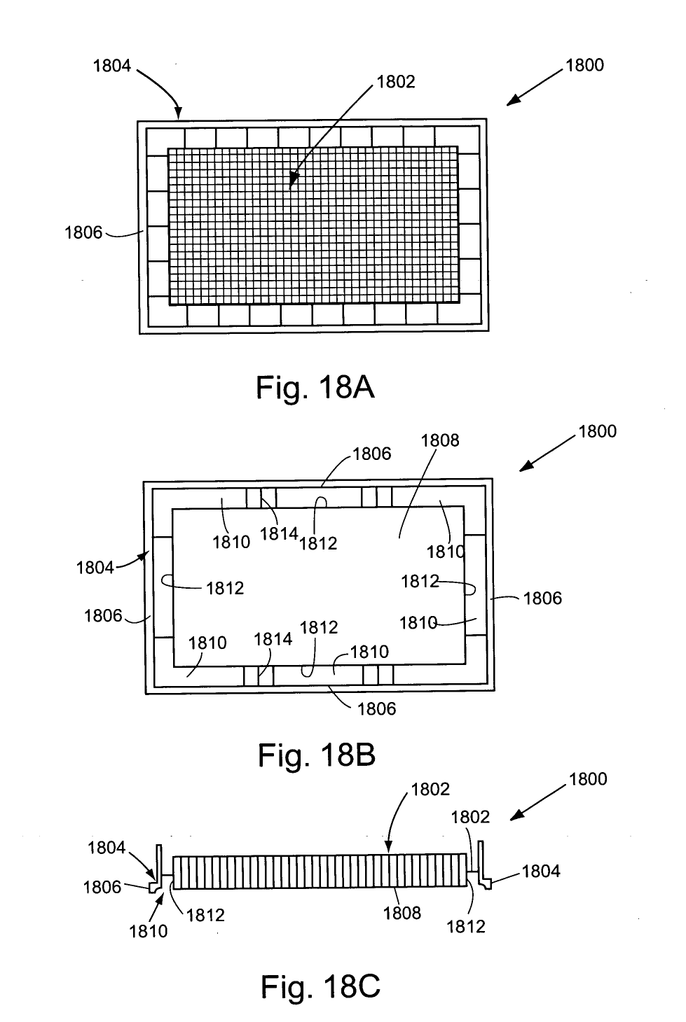

Another aspect of the invention applies specifically to the positioning of microtiter plates. To illustrate, microtiter plate 1800 is shown in FIGS. 18A-C. As shown, microtiter plate 1800 comprises well area 1802, which has many individual sample wells for holding samples and reagents. Microtiter plates (e.g., clear bottom plates, solid bottom plates, glass bottom plates, etc.) are fabricated in a wide variety of sample well configurations, including commonly available plates with 6, 12, 24, 48, 96, 192, 384, 768, 1536, 3456, 9600, or more wells. Microtiter plates are available from a variety of manufacturers including, e.g., Greiner America Corp. (Lake Mary, Fla., U.S.A.). Exemplary microtiter plates that are optionally positioned using the positioning devices of the invention are also described in, e.g., International Patent Application No. PCT/US2004/029068, entitled “MULTI-WELL CONTAINERS, SYSTEMS, AND METHODS OF USING THE SAME,” filed Sep. 3, 2004 by Zhang et al., which is incorporated by reference. Microtiter plate 1800 has outer wall 1804 having registration edge 1806 at its bottom. In addition, microtiter plate 1800 includes bottom surface 1808 below the well area on the bottom side of microtiter plate 1800. Bottom surface 1808 is separated from the outer wall 1804 by alignment member receiving area 1810. Alignment member receiving area 1810 is bounded by a surface of outer wall 1804 and by inner wall 1812 at the edge of bottom surface 1808. Although there may be some lateral supports 1814 in alignment member receiving area 1810, these areas are generally open between inner wall 1812 and an inner surface of the outer wall 1804.

According to certain aspects of the invention, to position a microtiter plate, the alignment members of a multi-well container station are optionally arranged to cooperate with inner wall 1812 of the microtiter plate. Inner wall 1812 is advantageously used, as inner wall 1812 is typically more accurately formed and is more closely associated with the perimeter of the sample well area, as compared to an outer wall of the plate 1800, such as wall 1804. Accordingly, aligning an inner wall (e.g., inner wall 1812) of a microtiter plate relative to alignment members is generally used in lieu of aligning with an outer wall, such as wall 1804. The increased positioning precision that is obtained by using an inner wall as the alignment surface makes possible the use of high-density microtiter plates, such as 1536-well plates. Further, by having the alignment members (e.g., alignment protrusions 1706 and 1708) cooperate with an inner wall 1812 of plate 1800, minimal structures are needed adjacent to the outside of the plate. In such a manner, a robotic arm or other transport device is able to readily access plate 1800. Having the protrusions positioned adjacent inner wall 1812 thereby facilitates translocating plate 1800. However, it will be appreciated that the alignment members or protrusions can be placed in alternative positions and still facilitate the precise positioning of the plate.

As also shown in FIGS. 17 A and B, multi-well container station 1700 also includes pushers 1712 and 1718 for positioning a microtiter plate along both the x-axis and the y-axis. When the microtiter plate is generally positioned adjacent to the x- and y-axis protrusions, the bottom surface of the microtiter plate is directly above top surface 1710 of vacuum plate 1704. Y-axis pusher 1712, which extends through slot 1714 in support structure 1702, is used to apply pressure to a y-axis side wall of the microtiter plate. Sufficient force is applied to the plate at the plate contact 1716 to push the microtiter plate against y-axis protrusions 1708. When the microtiter plate is pushed against y-axis protrusions 1708, x-axis pusher 1718, which extends through slot 1720 of support structure 1702, is used to push an x-axis wall of the microtiter plate towards x-axis protrusion 1706. In this manner, the microtiter plate is accurately and precisely positioned relative to both the x-axis and y-axis protrusions. It is sometimes advantageous, although not necessary, to have one or more of the pushers contact an inner wall of a microtiter plate rather than an outer wall. With this arrangement, the alignment members and pushers are underneath the microtiter plate. This leaves the area surrounding the exterior of the plate free of protrusions that could otherwise interfere with other devices that, for example, place the microtiter plate on the support.

As referred to above, the multi-well container positioning device embodiment shown in FIGS. 17 A and B includes vacuum plate 1704 that functions as a retaining device to hold and flatten a properly positioned container in a selected position. With both y-axis pusher 1712 and x-axis pusher 1718 applying sufficient force to precisely place the microtiter plate, a vacuum source (not shown) applies a vacuum via vacuum line 1722 through orifices 1724. Air source (not shown) applies air pressure through air line 1723 to effect movement of the pushers. Methods of positioning multi-well containers using the devices described herein a described further below.

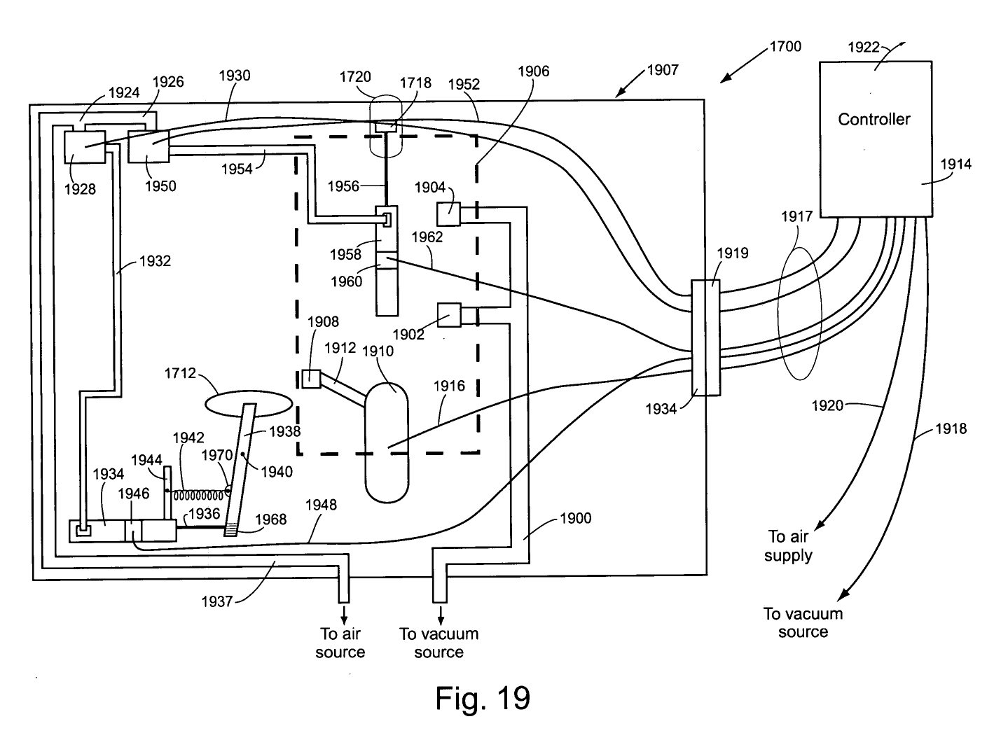

To further illustrate, FIG. 19 shows one embodiment of a container station that is optionally included in a multi-well container positioning device of the invention. A vacuum source (not shown) connects to vacuum line 1900 which connects to vacuum inlets 1902 and 1904. The vacuum line inlets 1902 and 1904 are connected to and communicate with chambers (not shown) of the container station.

The positioning devices of the invention can also include sensing switches or other means for sensing whether a vacuum effect is present between a multi-well container and the vacuum plate. For example, FIG. 17B shows vacuum switch hole 1732. The vacuum switch hole communicates the vacuum level to a vacuum sensing switch, which confirms a sufficient level of vacuum beneath the multi-well container. In such a manner, the vacuum force retaining the multi-well container can be measured and monitored while the container is retained against the vacuum plate 1704. If the vacuum level is insufficient, the sensing switch can send a signal to a controller, or to a human operator, that the container is not properly positioned and/or retained and thus is not ready for further processing. Conversely, if a vacuum is sensed, the switch can signal the controller to proceed with further processing.

An example of a container station that includes a sensing device is shown in FIG. 19, which generally shows a bottom side of a support structure with vacuum plate 1704 positioned on the top surface of the support structure. Although from the bottom view in FIG. 19 the vacuum plate is not visible, dotted line 1906 shows the general positioning of the vacuum plate on the other side of the support structure. The vacuum switch hole communicates with vacuum switch inlet 1908, which connects to vacuum switch 1910 through vacuum switch line 1912. Vacuum switch 1910 electrically connects to controller 1914 through control line 1916 for communicating status of vacuum to controller 1914. In that regard, controller 1914 receives a signal when sufficient vacuum is achieved at the vacuum plate to draw the microtiter plate firmly against the vacuum plate. Controller 1914 can also communicate with the vacuum source via control line 1918 and optionally to an air supply source (described below) via control line 1920. Controller 1914 can also receive direction and send status information to other system components via system connection line 1922. Controllers are described further below.

Once the vacuum source has securely retained the microtiter plate or other object against the vacuum plate, additional processes (e.g., material transfer, etc.) may be performed reliably and accurately in the microtiter plate. When processing of the microtiter plate or other object is completed, the vacuum source is typically deactivated to release the object from the vacuum plate.

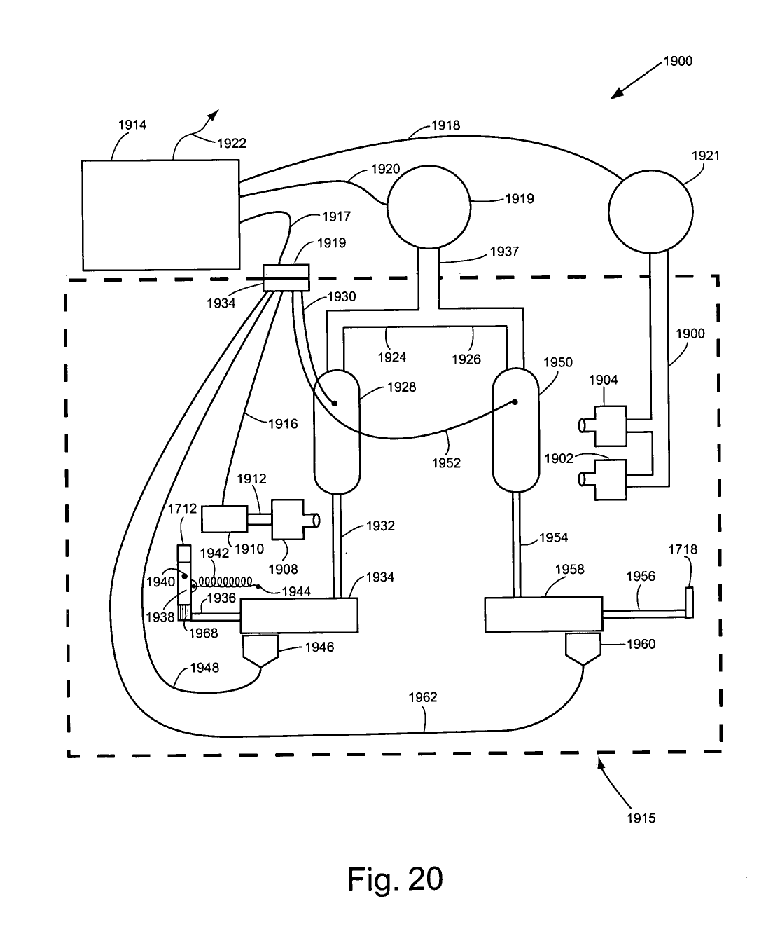

The multi-well container positioning devices of the invention typically have a controller or control system that coordinates the actions of the different components of the device or a system that includes the device. FIG. 20 shows one example of control system 1900 for container station 1915 of a positioning device of the invention. Control system 1900 generally comprises controller 1914 connected to container station 1915 through control line 1917. Control line 1917 may terminate in connector 1919 to facilitate connection to mating control connector 1934 on container station 1915. This arrangement facilitates connection and disconnection of the components. Controller 1914 may also be connected to other system components in a high throughput system through, e.g., system connection line 1922. For example, the controller 1914 matrices instructions from a central control system and reports status information in return.

Controller 1914 in this embodiment also controls vacuum source 1921 through vacuum source control line 1918 and optionally controls an air supply 1923 via air supply control line 1920. In such a manner, the controller can accept instructions or send status information to a high throughput system controller and control and monitor the precise positioning of a multi-well container.

In some embodiments, both x-axis pusher 1718 and y-axis pusher 1712 are activated by air pistons. Air supply 1923 provides pressurized air through air supply line 1920 which is directed into y-axis air supply line 1924 and x-axis air supply line 1926. Y-axis air supply line 1924 is received into y-axis air switch 1928 which acts as a valve to open or close y-axis supply line 1924. The y-axis air switch is directed by the controller 1914 through x-axis air switch control line 1930. When controller 1914 directs y-axis air switch 1928 to an open position, air pressure is received into y-axis piston air supply line 1932. Y-axis piston air supply line 1932 is connected to y-axis air piston 1934, which drives y-axis arm 1936. It will be appreciated that other mechanisms may be used to activate the pushers, such as hydraulic rams, electromagnetic actuators, or gear drives, for example.

Y-axis arm 1936 drives lever 1938 around pivot 1940. Accordingly, when air piston 1934 is activated, y-axis pusher pin 1712 is moved from its at-rest position. The at-rest position is defined by spring 1942 which attaches between lever 1938 and spring support 1944. In such a manner spring 1942 causes lever 1938 to pivot from pivot point 1940. In some embodiments, when air piston 1934 is not active, the spring causes y-axis pusher 1712 to be firmly engaged against the microtiter plate. Accordingly, when air piston 1934 is activated, y-axis pusher 1712 is moved away from a wall of the microtiter plate.

Air piston 1934 has y-axis magnet switch 1946 that communicates y-axis arm position 1936 to controller 1914 via magnetic switch control line 1948. In such manner, the controller receives a signal indicating the status of the position of y-axis arm 1936. For example, a signal may be placed on line 1948 when air piston 1934 has moved y-axis arm 1936 in a position that fully disengages y-axis pusher 1712 from the microtiter plate.

X-axis air switch 1950 is connected to controller 1914 through x-axis air switch control line 1952. When controller 1914 directs x-axis air switch 1950 to activate, air pressure is placed in x-axis piston air supply line 1954. Such air pressure drives x-axis arm 1956 of x-axis air piston 1958. X-axis magnetic switch 1960 communicates with controller 1914 through magnetic switch control line 1962 to generate a signal that indicates the position of x-axis arm 1956. In some embodiments, x-axis air piston 1958 is configured to retract x-axis pusher 1718 when air piston 1958 is deactivated and to force x-axis pusher 1718 against the microtiter plate when the x-axis air piston 1958 is activated. When x-axis air piston 1958 is activated and x-axis pusher 1718 is driven against the microtiter plate, magnetic switch 1960 typically generates a signal on line 1962 which indicates to the controller 1914 that the microtiter plate is positioned along the x-axis.

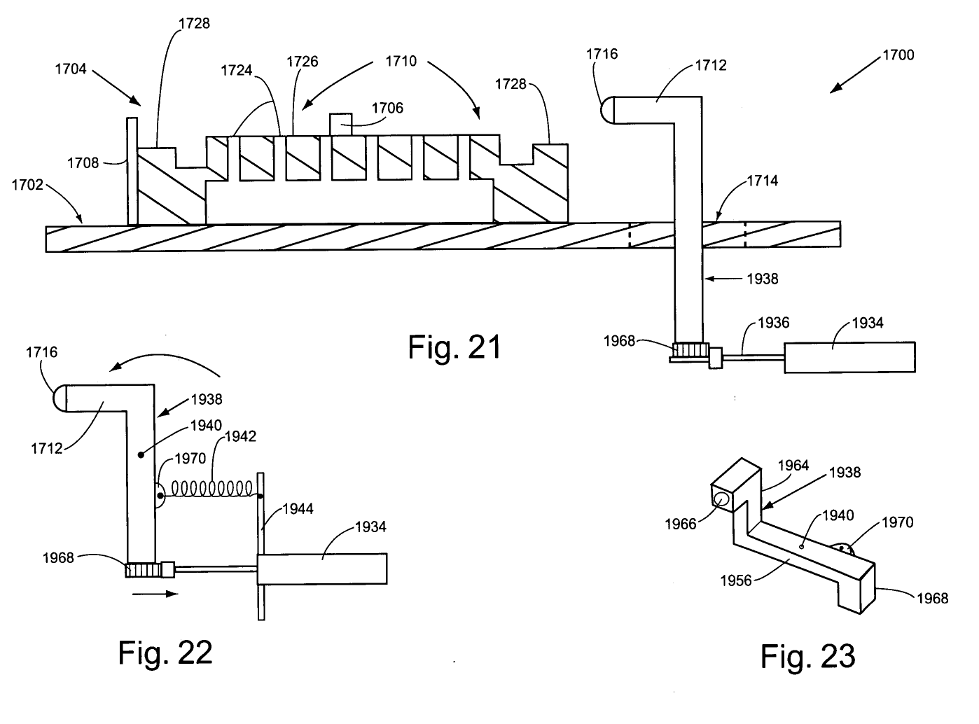

Referring now to also to FIGS. 21-23, the operation of one embodiment of a y-axis pusher is further described. The y-axis pusher in this embodiment is a generally L-shaped member having vertical portion 1964 and horizontal portion 1956. Contact connector 1966 is positioned at the top end of vertical portion 1964 for attaching plate contact 1716. Horizontal portion 1956 extends at a right angle from vertical portion 1964 and ends with enlarged arm contact 1968. Arm contact 1968 is constructed and arranged to cooperate with y-axis arm 1936 of y-axis piston 1934. In some embodiments, y-axis arm 1936 terminates with an adjustment mechanism for adjusting the length of y-axis arm 1936.

Horizontal portion 1956 of lever 1938 has pivot 1940 for receiving a pivot pin that enables y-axis pusher 1712 to pivot about pivot point 1940. Horizontal portion 1956 also has spring connector 1970 for receiving one end of spring 1942. The other end of spring 1942 is connected to a stable support such as stable support 1944. In one configuration, spring support 1944 is attached to the y-axis air piston and the support structure of the positioning device. When spring 1942 is connected between spring contact 1970 and stable support 1944, the spring acts to draw arm contact 1968 towards air piston 1934. As in the illustrated example the lever 1938 is configured to pivot about pivot point 1940, the plate contact 1716 is rotated in a direction generally away from the air piston.

In the illustrated embodiment, when air piston 1934 is not activated, spring 1942 acts to press plate contact 1716 toward y-axis wall 1733 of vacuum plate 1704. If a microtiter plate is generally positioned on the vacuum plate 1704, plate contact 1716 contacts a y-axis wall of the microtiter plate and pushes the plate toward y-axis protrusions 1708. For optimum positioning performance, y-axis pusher 1712 should provide a constant and stable positioning force to the y-axis wall of a microtiter plate. To assure a constant pressure, the force exerted by y-axis pusher 1712 is determined by the spring 1942. As springs typically provide a constant force, the microtiter plate will be positioned with a known and constant tensioning force.

In certain embodiments, after the microtiter plate is positioned relative to the y-axis, the y-axis pusher continues to exert a force against the y-axis wall of the microtiter plate. When the x-axis pusher is activated, the x-axis pusher 1718 moves the microtiter plate towards the x-axis protrusion 1706. Accordingly, the microtiter plate is moved relative the plate contact and the lever 1938 while the y-axis pusher continues to exert a force against the microtiter plate. More specifically, levers 1938 typically maintain stability in the x-axis direction to avoid skewing and maintain a constant and stable y-axis force. To achieve such stability for lever 1938, lever 1938 is constructed as a pivoting lever which pivots about pivot point 1940. Since pivot point 1940 and the plate contact are generally aligned with the x-axis of the microtiter plate, the pivot acts to substantially stabilize the x-axis positioning of the plate contact 1716. Accordingly, when y-axis pusher 1712 is fully pressed against the microtiter plate, and x-axis pusher 1718 moves the microtiter plate towards x-axis protrusion 1706, y-axis pusher 1712 maintains a constant and stable y-axis force. Skewing is also avoided by constructing the plate contact 1716 to have a low-friction contact point with the microtiter plate.

Although in some embodiments, the y-axis pusher is configured as a pivoting lever, it will be appreciated that other configurations may be used to move a microtiter plate towards y-axis protrusions. For example, plate contact 1716 could be directly attached to an air piston arm with the air piston being driven by a constant and stable air force to move the plate contact stably and constantly toward the microtiter plate wall.

Once the vacuum source has securely retained the microtiter plate against vacuum plate 1704, additional processes may be performed reliably and accurately to the microtiter plate. When processing of the microtiter plate is completed, the vacuum source is typically deactivated to release the microtiter plate from the vacuum plate 1704. In this process, both x-axis pusher 1718 and y-axis pusher 1712 are released. With the vacuum off and the pushers released, the microtiter plate can be easily lifted from the positioning device, e.g., manually, using a robotic translocation device, etc. for further processing.

Referring further to FIG. 19, which schematically depicts one exemplary arrangement of multi-well container station components for a multi-well container positioning device according to one embodiment of the invention. FIG. 19 generally shows a bottom side of support structure 1907 with vacuum plate 1704 positioned on the top surface of support structure 1907. Although from the bottom view in FIG. 19, vacuum plate 1704 is not visible, dotted line 1906 shows the general positioning of vacuum plate 1704 on the other side of support structure 1907.

An air source (not shown) is connected to air supply 1937 which runs generally on the perimeter of support structure 1907 to y-axis air supply line 1924 and x-axis air supply line 1926. Y-axis air supply line 1924 connects to y-axis air switch 1928 and x-axis air supply line 1926 connects to x-axis air switch 1950. Air switches 1928 and 1950 electrically connect via electrical lines 1930 and 1952 to electrical connector 1934, and then connect to controller 1914 through connector 1919 and control line 1917. Accordingly, controller 1914 can then direct the air switches to activate or deactivate the air pistons. For example, controller 1914 can direct y-axis air switch 1928 to activate, thereby pressurizing y-axis air supply line 1932 and driving the arm 1936 of air piston 1934. When arm 1936 is driven, lever 1938 pivots about pivot point 1940 and pulls y-axis pusher lever away from the vacuum plate. When controller 1922 deactivates y-axis air switch 1928, air bleeds from piston 1934 and spring 1942, which is under tension between spring contact 1970 and stable support 1944, tensions the y-axis pusher towards the vacuum plate. Magnetic switch 1946 communicates with controller 1914 through control line 1948 for indicating y-axis pusher position.

Controller 1914 also controls x-axis air switch 1950, which when opened pressurizes x-axis piston air supply line 1954 for driving x-axis arm 1956 of x-axis air piston 1960. Accordingly, x-axis pusher 1718 is propelled toward vacuum plate 1704. In some embodiments, x-axis pusher 1718 is directly attached to x-axis arm 1956. It will be appreciated that other configurations and arrangements may be used for attaching the x-axis pusher to the x-axis arm. For example, certain of these other embodiments are described further above. To conserve space, the x-axis piston is arranged so that arm 1956 is pulled into piston body 1958 when air pressure is applied to piston 1958. When pressure is released, arm 1956 travels in a manner so that x-axis pusher 1718 is released from any retained microtiter plate. Magnetic switch 1960 connects to controller 1914 via line 1962 so that controller 1914 can receive a signal that x-axis pusher 1718 is fully engaged against the microtiter plate.

The invention also provides multi-well container processing systems that can rapidly remove and/or dispense fluids from and/or to selected wells of multi-well containers, e.g., as part of a high-throughput screening or washing procedure. In certain embodiments, for example, these systems, which are typically highly automated, include fluid removal components that include at least one negative pressure source, such as a vacuum pump, centrifugal blower, or the like in addition to at least one fluid removal head. Negative pressure sources are typically operably connected to fluid removal heads via tubes or other conduits such that negative pressure can be applied at inlets to tips of the fluid removal heads by the negative pressure source to effect fluid removal from multi-well containers. Fluid removal heads that are optionally utilized in the systems of the invention are described further below and in, e.g., U.S. Provisional Patent Application No. 60/598,994, entitled “MULTI-WELL CONTAINER PROCESSING SYSTEMS, SYSTEM COMPONENTS, AND RELATED METHODS,” filed Aug. 4, 2004 by Micklash II et al. and International Publication No. WO 2004/091746, entitled “MATERIAL REMOVAL AND DISPENSING DEVICES, SYSTEMS, AND METHODS,” filed Apr. 7, 2004 by Micklash II et al., which are both incorporated by reference. In addition to the multi-well container positioning devices described herein, these multi-well container processing systems also typically include dispensing components that are structured to dispense materials (e.g., fluidic materials, etc.) into selected wells of multi-well containers. For example, dispensing components typically include at least one dispenser that aligns with wells disposed in one or more multi-well containers when the multi-well containers are disposed proximal to the dispenser. Controllers are also generally operably connected to one or more system components. Various other components are also optionally included in the systems of the present invention. Certain of these are described further below.

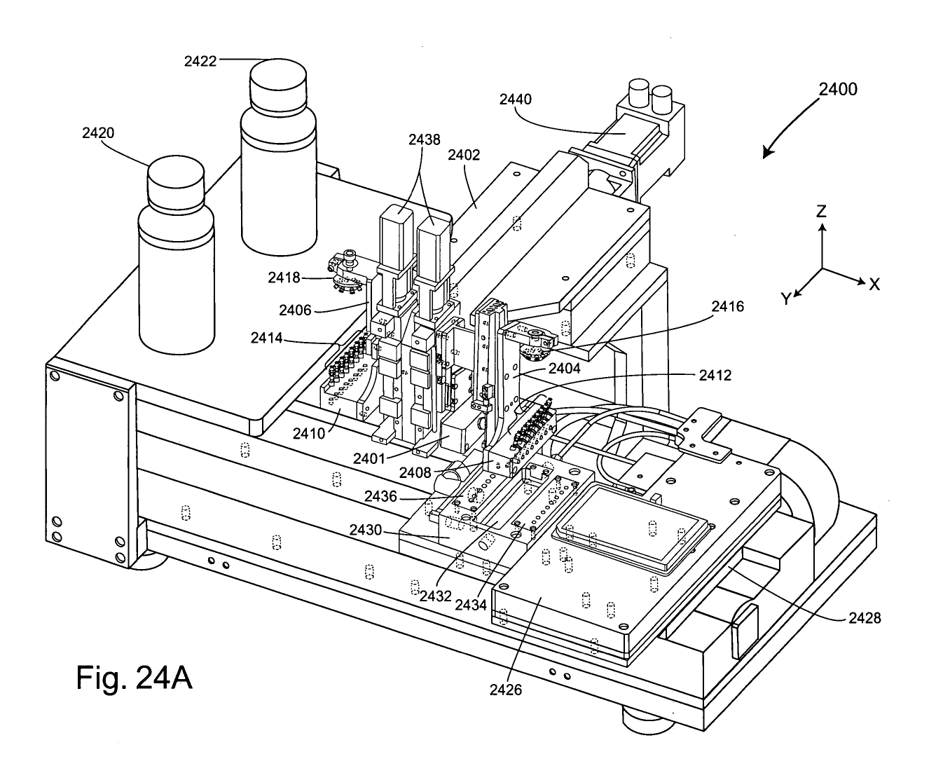

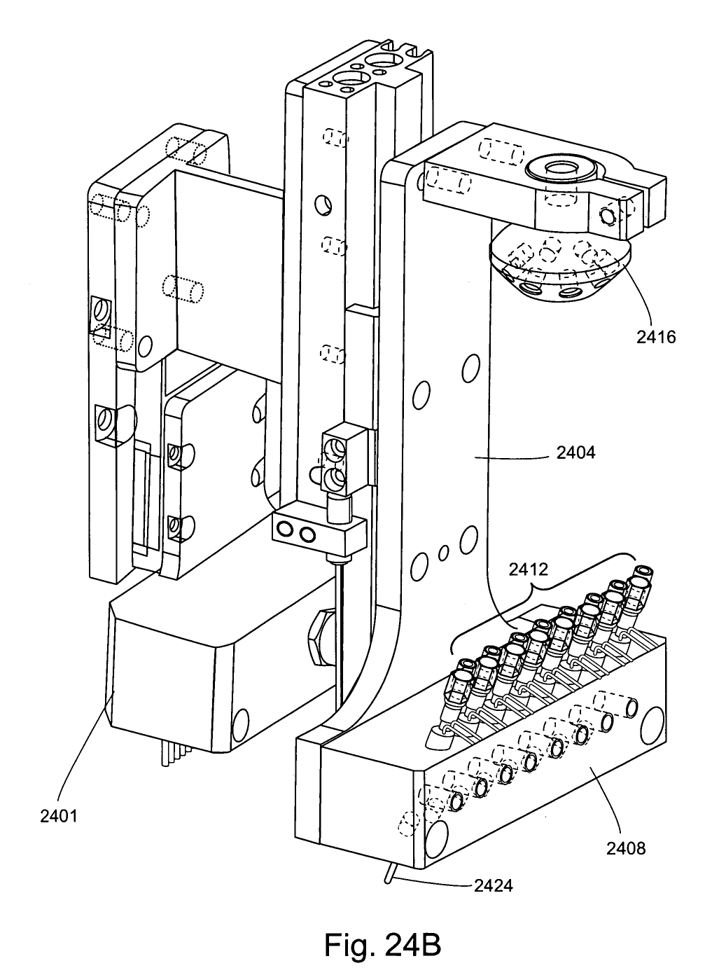

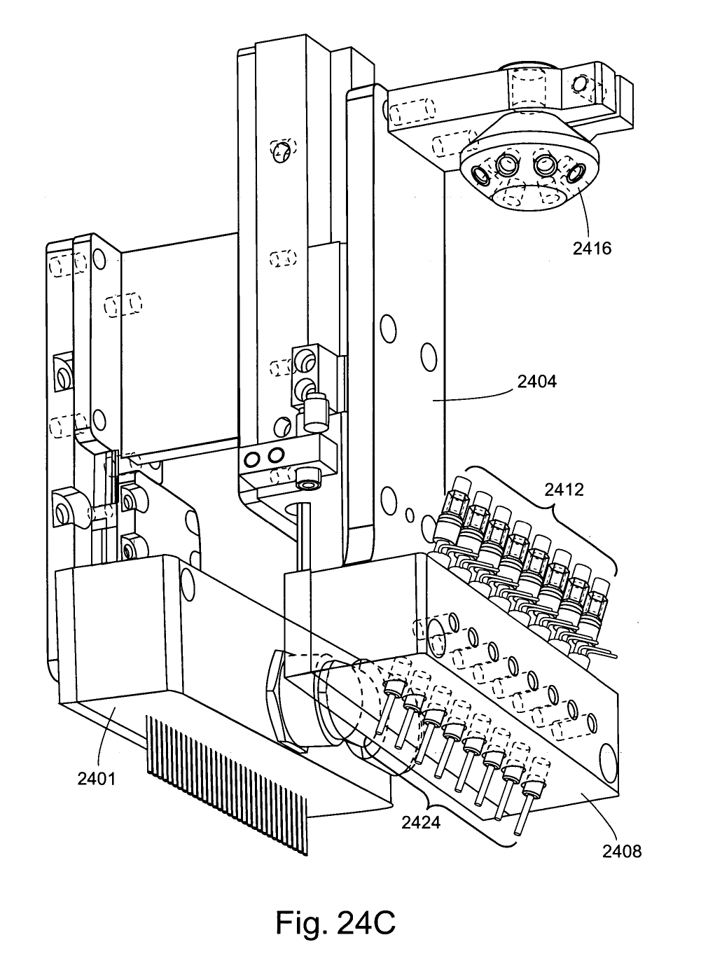

To further illustrate the systems of the invention, FIG. 24A schematically illustrates one embodiment of a multi-well container processing system from a perspective view. As shown, multi-well container processing system 2400 includes fluid removal head 2401 mounted on Y- and Z-axis translocation component 2402. Translocation component 2402 is structured to translocate fluid removal head 2401 and/or other components such as dispensing components (described further below) along the Z-axis, e.g., to access a multi-well container for fluid removal. Translocation component 2402 is also structured to translocate these components along the Y-axis, e.g., to move fluid removal head 2401 and dispensing components across a multi-well container. More specifically, drive mechanisms 2438 effect Z-axis translation, whereas drive mechanism 2440 effects Y-axis movement of these components. Drive mechanism 2438 and 2440 are typically servo motors, stepper motors, or the like. Although not shown in FIG. 24A, a tube or other conduit operably connects fluid removal head 2401 to a negative pressure source. Essentially any negative pressure source is optionally utilized in these systems to effect multi-well container positioning as described herein and/or fluid removal. In some embodiments, for example, negative pressure sources include pumps, such as vacuum or centrifugal blower pumps that can create suction forces. Many different pumps of this nature are known in the art and are commercially available from various suppliers. Negative pressure sources are generally configured (e.g., controller directed) to apply negative pressure at various rates. At least one valve (e.g., a solenoid valve, etc.) that is structured to regulate pressure flow from a negative pressure source is generally operably connected to fluid removal head 2401 and/or the tube. In addition, one or more traps (e.g., fluid traps, containers, filters, etc.) are typically disposed in the fluid line between fluid removal head 2401 and the negative pressure source to trap and store materials (e.g., waste materials or the like) removed from multi-well containers for subsequent disposal.

As also shown, multi-well container processing system 2400 further includes dispensing components 2404 and 2406 mounted on translocation component 2402. Translocation component 2402 also translates or moves dispensing components 2404 and 2406 along the Y- and Z-axes. Dispensing components 2404 and 2406 include dispense heads 2408 and 2410. Although not shown, tubes or other fluid conduits typically fluidly connect solenoid valves 2412 and 2414 to manifolds 2416 and 2418, respectively. The dispensing components of these systems optionally include peristaltic pumps, syringe pumps, bottle valves, etc. Manifolds 2416 and 2418 are also typically in fluid communication with one or more containers (e.g., fluid containers 2420 and 2422) via tubes or other fluid conduits (not shown). Fluid is generally conveyed from these containers to dispense heads 2408 and 2410 by operably connected fluid direction components, such as pumps or the like.

FIGS. 24 B and C schematically depict a detailed top and bottom perspective view, respectively, of fluid removal head 2401 and dispense head 2408 from multi-well container processing system 2400 of FIG. 24A. In the embodiment shown, dispensers or dispense tips 2424 are disposed in dispense head 2408 at angles relative to the vertical or Z-axis. During operation, once fluid has been removed from a multi-well container, dispense head 2408 is optionally utilized to fill selected wells in the plate, e.g., with a cleaning fluid, reagent, or the like. Dispense tips 2424 are angled so that fluid is dispensed onto the sides of the selected wells to ensure that non-removed material (e.g., cells, etc.) disposed on the bottom of the selected wells is not disturbed when fluids are dispensed. Optionally, dispense tips are disposed substantially parallel, e.g., with the Z-axis. This is illustrated, for example, in dispense head 2410. In some embodiments, the dispensing component is structured to dispense the materials to a plurality of multi-well containers substantially simultaneously. Dispensing components for dispensing fluids to multiple multi-well containers, which are optionally adapted for use in the systems of the present invention are described further in, e.g., U.S. Pat. No. 6,659,142, entitled “APPARATUS AND METHODS FOR PREPARING FLUID MIXTURES,” to Downs et al., and International Publication No. WO 02/076830, entitled “MASSIVELY PARALLEL FLUID DISPENSING SYSTEMS AND METHODS,” filed Mar. 27, 2002 by Downs et al., which are both incorporated by reference.

As also shown in FIG. 24A, multi-well container processing system 2400 includes multi-well container positioning device 2426, which precisely positions and retains multi-well containers (as described herein) relative to fluid removal head 2401 and dispense heads 2408 and 2410 so that materials can be removed from and/or dispensed into selected wells of a multi-well container. Positioning device 2426 is mounted on X-axis translocation component 2428, which moves (e.g., slides) positioning device 2426 along the X-axis to align wells disposed in multi-well containers with tip inlets to fluid removal head 2401 and dispense tips of dispense heads 2408 and 2410. A drive mechanism (not shown), such as a servo motor, a stepper motor, or the like, is generally operably connected to X-axis translocation component 2428 to effect movement of positioning device 2426 and/or other components.

Multi-well container processing system 2400 also includes cleaning or washing component 2430, which is structured to wash or otherwise clean fluid removal head 2401 and dispense tips of dispense heads 2408 and 2410. Washing component 2430 is also mounted on X-axis translocation component 2428 (e.g., a multi-well container moving component, etc.). In addition to moving positioning device 2426, translocation component 2328 also moves (e.g., slides) washing component 2430 along the X-axis to align fluid removal head 2401 and dispense tips of dispense heads 2408 and 2410 with components of washing component 2430. More particularly, washing component 2430 includes recirculation bath or trough 2432 into which translocation component 2402 lowers fluid removal head 2401 for cleaning, e.g., after materials have been removed from a multi-well container positioned and retained on positioning device 2426. In addition, washing component 2430 also includes vacuum ports 2434 and 2436 into which dispense tips of dispense heads 2408 and 2410 are lowered, respectively, by translocation component 2402 to remove, e.g., fluid or other materials adhered to external surfaces of the dispense tips.

The systems of the invention optionally further include various incubation components and/or multi-well container storage components. In some embodiments, for example, systems include incubation components that are structured to incubate or regulate temperatures within multi-well containers. To illustrate, many cell-based or other types of assays include incubation steps and can be performed using these systems. Additional details regarding incubation devices that are optionally adapted for use with the systems of the present invention are described in, e.g., International Publication No. WO 03/008103, entitled “HIGH THROUGHPUT INCUBATION DEVICES,” filed Jul. 18, 2002 by Weselak et al., which is incorporated by reference. In certain embodiments, multi-well container processing systems of the invention include multi-well container storage components that are structured to store one or more multi-well containers. Such storage components typically include multi-well container hotels or carousels that are known in the art and readily available from various commercial suppliers, such as Beckman Coulter, Inc. (Fullerton, Calif., USA). For example, in one embodiment, a multi-well container processing system of the invention includes a stand-alone station in which a user loads a number of multi-well containers to be washed or otherwise processed into one or more storage components of the system for automated processing of the plates. In these embodiments, the systems of the invention also typically include one or more robotic gripper apparatus that move plates, e.g., between incubation or storage components and positioning components. Robotic grippers that are suitable for use in the systems of the invention are described further below or otherwise known in the art. For example, a TECAN® robot, which is commercially available from Clontech (Palo Alto, Calif., USA), is optionally adapted for use in the systems described herein.

In certain embodiments, the systems of the invention also include at least one detector or detection component that is structured to detect detectable signals produced, e.g., in wells of multi-well containers. Suitable signal detectors that are optionally utilized in these systems detect, e.g., fluorescence, phosphorescence, radioactivity, mass, concentration, pH, charge, absorbance, refractive index, luminescence, temperature, magnetism, or the like. Detectors optionally monitor one or a plurality of signals from upstream and/or downstream of the performance of, e.g., a given assay step. For example, the detector optionally monitors a plurality of optical signals, which correspond in position to “real time” results. Example detectors or sensors include photomultiplier tubes, CCD arrays, optical sensors, temperature sensors, pressure sensors, pH sensors, conductivity sensors, scanning detectors, or the like. Each of these as well as other types of sensors is optionally readily incorporated into the systems described herein. The detector optionally moves relative to multi-well containers or other assay components, or alternatively, multi-well containers or other assay components move relative to the detector. In certain embodiments, for example, detection components are coupled to translation components that move the detection components relative to multi-well containers positioned on positioning devices of the systems described herein. Optionally, the systems of the present invention include multiple detectors. In these systems, such detectors are typically placed either in or adjacent to, e.g., a multi-well container or other vessel, such that the detector is within sensory communication with the multi-well container or other vessel (i.e., the detector is capable of detecting the property of the plate or vessel or portion thereof, the contents of a portion of the plate or vessel, or the like, for which that detector is intended).

The detector optionally includes or is operably linked to a computer, e.g., which has system software for converting detector signal information into assay result information or the like. For example, detectors optionally exist as separate units, or are integrated with controllers into a single instrument. Integration of these functions into a single unit facilitates connection of these instruments with the computer, by permitting the use of few or a single communication port(s) for transmitting information between system components. Computers and controllers are described further below. Detection components that are optionally included in the systems of the invention are described further in, e.g., Skoog et al., Principles of Instrumental Analysis, 5^{th} Ed., Harcourt Brace College Publishers (1998) and Currell, Analytical Instrumentation: Performance Characteristics and Quality, John Wiley & Sons, Inc. (2000), which are both incorporated by reference.

The systems of the invention optionally also include at least one robotic gripping component that is structured to grip and translocate multi-well containers between components of the multi-well container processing systems and/or between the multi-well container processing systems and other locations (e.g., other work stations, etc.). In certain embodiments, for example, systems further include gripping components that move multi-well containers between positioning components, incubation components, and/or detection components. A variety of available robotic elements (robotic arms, movable platforms, etc.) can be used or modified for use with these systems, which robotic elements are typically operably connected to controllers that control their movement and other functions. Exemplary robotic gripping devices that are optionally adapted for use in the systems of the invention are described further in, e.g., U.S. Pat. No. 6,592,324, entitled “GRIPPER MECHANISM,” issued Jul. 15, 2003 to Downs et al. and International Publication No. WO 02/068157, entitled “GRIPPING MECHANISMS, APPARATUS, AND METHODS,” filed Feb. 26, 2002 by Downs et al., which are both incorporated by reference.

The multi-well container processing systems of the invention also typically include controllers that are operably connected to one or more components (e.g., multi-well container positioning devices, solenoid valves, pumps, translocation components, etc.) of the system to control operation of the components. More specifically, controllers are generally included either as separate or integral system components that are utilized, e.g., to regulate the pressure applied by negative pressure sources (e.g., in vacuum plate orifices, at fluid removal head tip inlets, etc.), the quantities of samples, reagents, cleaning fluids, or the like dispensed from dispense heads, the movement of pushers, the movement of translocation components, e.g., when positioning multi-well containers relative to fluid removal or dispense heads, etc. Controllers and/or other system components is/are optionally coupled to an appropriately programmed processor, computer, digital device, or other information appliance (e.g., including an analog to digital or digital to analog converter as needed), which functions to instruct the operation of these instruments in accordance with preprogrammed or user input instructions, receive data and information from these instruments, and interpret, manipulate and report this information to the user.

Any controller or computer optionally includes a monitor that is often a cathode ray tube (“CRT”) display, a flat panel display (e.g., active matrix liquid crystal display, liquid crystal display, etc.), or others. Computer circuitry is often placed in a box, which includes numerous integrated circuit chips, such as a microprocessor, memory, interface circuits, and others. The box also optionally includes a hard disk drive, a floppy disk drive, a high capacity removable drive such as a writeable CD-ROM, and other common peripheral elements. Inputting devices such as a keyboard or mouse optionally provide for input from a user.

The computer typically includes appropriate software for receiving user instructions, either in the form of user input into a set of parameter fields, e.g., in a GUI, or in the form of preprogrammed instructions, e.g., preprogrammed for a variety of different specific operations. The software then converts these instructions to appropriate language for instructing the operation of one or more controllers to carry out the desired operation, e.g., varying or selecting the rate or mode of movement of various system components, directing translation of robotic gripping apparatus, fluid removal heads, fluid dispensing heads, or of one or more multi-well containers or other vessels, or the like. The computer then receives the data from, e.g., sensors/detectors included within the system, and interprets the data, either provides it in a user understood format, or uses that data to initiate further controller instructions, in accordance with the programming, e.g., such as in monitoring incubation temperatures, detectable signal intensity, or the like. More specifically, the software utilized to control the operation of the systems described herein typically includes logic instructions, e.g., that direct translocation components to lower the tips of fluid removal heads to a first position in the wells of multi-well containers, and that direct negative pressure sources to apply a first negative pressure to the tips as the tips are lowered and/or once the tips are at the first position in the wells. In addition, this software also generally includes logic instructions, e.g., that direct translocation components to raise the tips, after selected volumes of fluid have been removed from wells, to a second position in the wells or proximal to the openings to the wells, and that direct the negative pressure sources to apply a second negative pressure to the tips that is greater than the first negative pressure such that air is drawn through the vent openings to effect removal of adherent fluid from the tips and from the sides of the wells. Computer program products are described further below.

The computer can be, e.g., a PC (Intel x86 or Pentium chip-compatible DOS™, OS2™, WINDOWS™, WINDOWS NT™, WINDOWS95™, WINDOWS98™, WINDOWS2000™, WINDOWS XP™, LINUX-based machine, a MACINTOSH™, Power PC, or a UNIX-based (e.g., SUN™ work station) machine) or other common commercially available computer that is known to one of skill. Standard desktop applications such as word processing software (e.g., Microsoft Word™ or Corel WordPerfect™) and database software (e.g., spreadsheet software such as Microsoft Excel™, Corel Quattro Pro™, or database programs such as Microsoft Access™ or Paradox™) can be adapted to the present invention. Software for performing, e.g., multi-well container positioning, fluid removal from selected wells of a multi-well container is optionally constructed by one of skill using a standard programming language such as AppleScript, Visual basic, Fortran, Basic, Java, or the like.

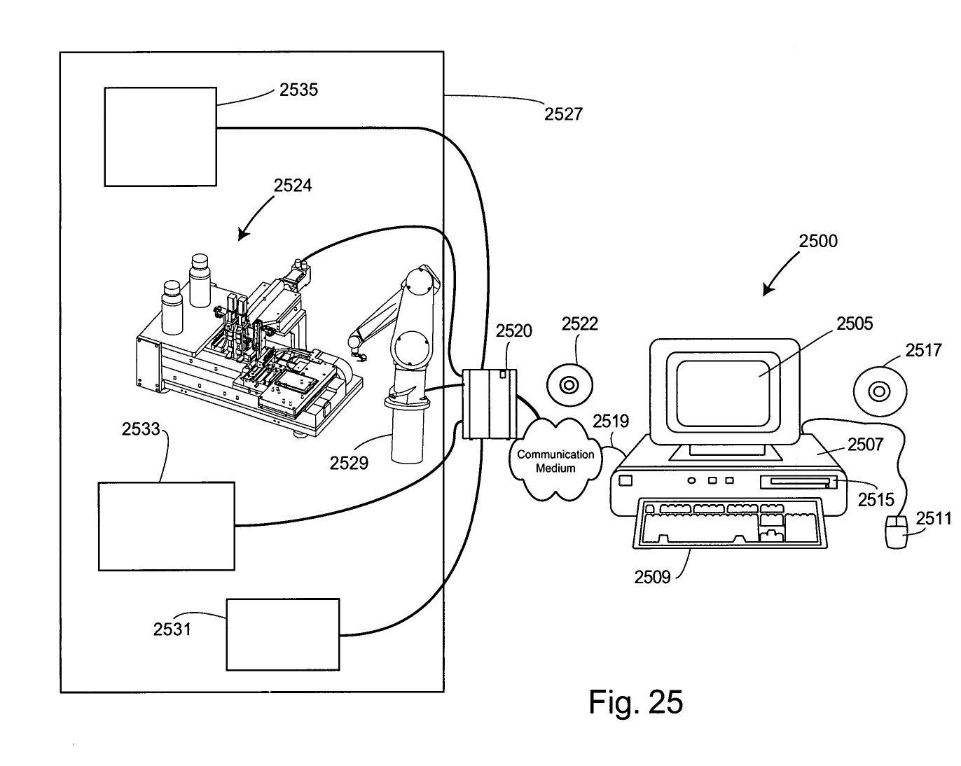

FIG. 25 is a schematic showing an exemplary multi-well container processing system including an information appliance in which various aspects of the present invention may be embodied. As will be understood by practitioners in the art from the teachings provided herein, the invention is optionally implemented in hardware and software. In some embodiments, different aspects of the invention are implemented in either client-side logic or server-side logic. As will also be understood in the art, the invention or components thereof may be embodied in a media program component (e.g., a fixed media component) containing logic instructions and/or data that, when loaded into an appropriately configured computing device, cause that apparatus or system to perform according to the invention. As will additionally be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

FIG. 25 shows information appliance or digital device 2500 that may be understood as a logical apparatus (e.g., a computer, etc.) that can read instructions from media 2517 and/or network port 2519, which can optionally be connected to server 2520 having fixed media 2522. Information appliance 2500 can thereafter use those instructions to direct server or client logic, as understood in the art, to embody aspects of the invention. One type of logical apparatus that may embody the invention is a computer system as illustrated in 2500, containing CPU 2507, optional input devices 2509 and 2511, disk drives 2515 and optional monitor 2505. Fixed media 2517, or fixed media 2522 over port 2519, may be used to program such a system and may represent a disk-type optical or magnetic media, magnetic tape, solid state dynamic or static memory, or the like. In specific embodiments, the aspects of the invention may be embodied in whole or in part as software recorded on this fixed media. Exemplary computer program products are described further below. Communication port 2519 may also be used to initially receive instructions that are used to program such a system and may represent any type of communication connection. Optionally, aspects of the invention are embodied in whole or in part within the circuitry of an application specific integrated circuit (ACIS) or a programmable logic device (PLD). In such a case, aspects of the invention may be embodied in a computer understandable descriptor language, which may be used to create an ASIC, or PLD. FIG. 25 also includes multi-well container processing system 2527, which includes multi-well container positioning device and fluid removal station 2524, robotic gripping component 2529, incubation component 2531, multi-well container storage component 2533, and detection component 2535. These system components are typically operably connected to information appliance 2500 directly or via server 2520. During operation, fluid removal station 2524 typically removes fluids from selected wells of multi-well containers positioned and retained on a positioning device of fluid removal station 2524, e.g., as part of a process to clean the containers, and robotic gripping component 2529 moves the containers between the components of multi-well container processing system 2527.

System components (e.g., multi-well container positioning device components, material handling device components, washing station components, etc.) are optionally formed by various fabrication techniques or combinations of such techniques including, e.g., machining, stamping, engraving, injection molding, cast molding, embossing, extrusion, etching (e.g., electrochemical etching, etc.), or other techniques. These and other suitable fabrication techniques are generally known in the art and described in, e.g., Altintas, Manufacturing Automation: Metal Cutting Mechanics, Machine Tool Vibrations, and CNC Design, Cambridge University Press (2000), Molinari et al. (Eds.), Metal Cutting and High Speed Machining, Kluwer Academic Publishers (2002), Stephenson et al., Metal Cutting Theory and Practice, Marcel Dekker (1997), Rosato, Injection Molding Handbook, 3^{rd} Ed., Kluwer Academic Publishers (2000), Fundamentals of Injection Molding, W. J. T. Associates (2000), Whelan, Injection Molding of Thermoplastics Materials, Vol. 2, Chapman & Hall (1991), Fisher, Extrusion of Plastics, Halsted Press (1976), and Chung, Extrusion of Polymers: Theory and Practice, Hanser-Gardner Publications (2000). In certain embodiments, following fabrication system components are optionally further processed, e.g., by coating surfaces with a hydrophilic coating, a hydrophobic coating (e.g., a Xylan 1010DF/870 Black coating available from Whitford Corporation (West Chester, Pa., USA), etc.), or the like, e.g., to prevent interactions between component surfaces and reagents, samples, or the like.

Device and system component fabrication materials are generally selected according to properties, such as reaction inertness, durability, expense, or the like. In some embodiments, for example, components are fabricated from various metallic materials, such as stainless steel, anodized aluminum, or the like. Optionally, components are fabricated from polymeric materials such as, polytetrafluoroethylene (TEFLON™), polypropylene, polystyrene, polysulfone, polyethylene, polymethylpentene, polydimethylsiloxane (PDMS), polycarbonate, polyvinylchloride (PVC), polymethylmethacrylate (PMMA), or the like. Polymeric parts are typically economical to fabricate, which affords disposability. Component parts are also optionally fabricated from other materials including, e.g., glass, silicon, or the like.

IV. Computer Program Products

It will be appreciated that various embodiments of the present invention provide methods and/or systems for positioning and retaining multi-well containers that can be implemented at least in part on a general purpose or special purpose information handling appliance using a suitable programming language such as Java, C++, C#, Perl, Python, Cobol, C, Pascal, Fortran, PLI, LISP, assembly, etc., and any suitable data or formatting specifications, such as HTML, XML, dHTML, tab-delimited text, binary, etc. In the interest of clarity, not all features of an actual implementation are described herein. It will be understood that in the development, of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

To generally illustrate certain control software that can implement aspects of the invention, one computer program product includes a computer readable medium having logic instructions for positioning a multi-well container on a vacuum plate of a multi-well container positioning device as described herein such that orifices disposed through the vacuum plate substantially align with regions of a bottom surface of the multi-well container that are disposed between adjacent wells of the multi-well container using at least one pusher. Pushers are described further above. In certain embodiments, the computer program product also includes logic instructions for applying negative pressure through the orifices such that the shape of the bottom surface of the multi-well container substantially conforms to a contour of the vacuum plate using at least one negative pressure source. Exemplary computer readable media include, e.g., a CD-ROM, a floppy disk, a tape, a flash memory device or component, a system memory device or component, a hard drive, a data signal embodied in a carrier wave, and the like.

Another exemplary computer program product includes a computer readable medium having logic instructions for: receiving an input selection of an applied negative pressure to multiple chambers of a multi-well container positioning device as described herein that is substantially simultaneous or that is in a selected sequence, and applying negative pressure to the chambers of the multi-well container positioning device with a negative pressure source in accordance with the input selection. In some embodiments, the computer program product includes logic instructions for pushing a multi-well container into a selected position on a vacuum plate of the multi-well container positioning device using at least one pusher. In certain embodiments, the computer program product includes logic instructions for receiving an input pressure level to apply to one or more of the chambers of the multi-well container positioning device.

V. Multi-Well Container Positioning Methods

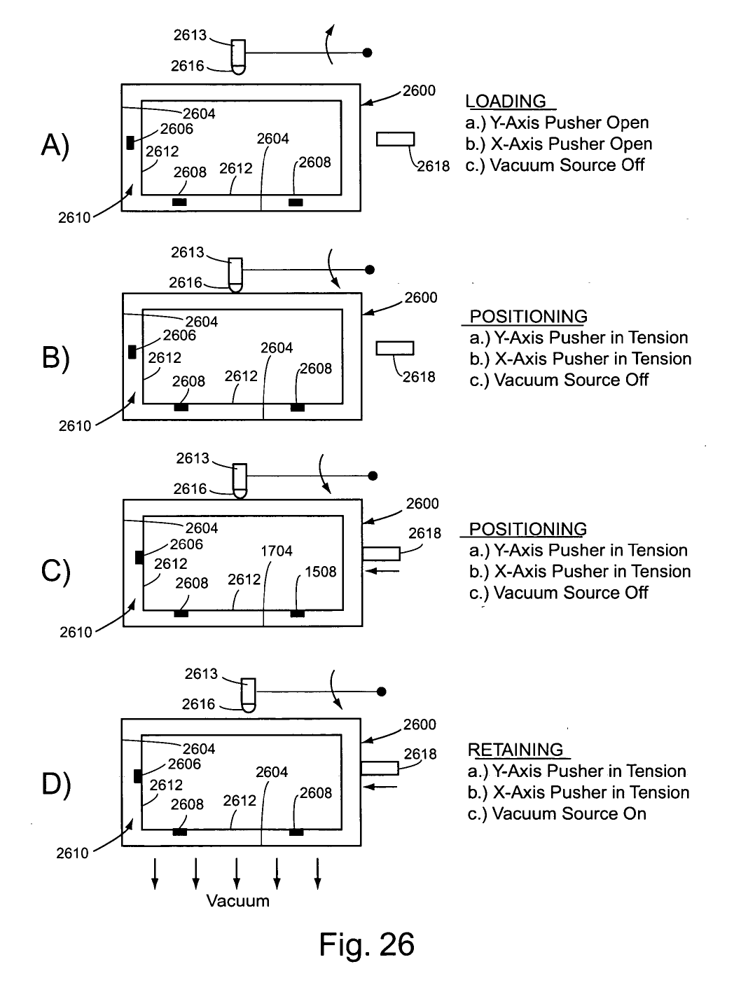

The invention also provides methods of positioning multi-well containers for further processing, such as fluid dispensing, material removal, assaying, synthesis reactions, among other processes. To illustrate with reference to FIGS. 26A-D, one embodiment of a general progression of positioning a multi-well container in multi-well container station 2600 is described. It is recognized that the positioning device can employ approaches that are equivalent to those illustrated to move a multi-well container into a selected position on the vacuum plate. Similarly, although the figures show the positioning of a microtiter plate in particular, one can readily adapt the arrangement of the positioning device components to position objects other than microtiter plates. In particular, FIGS. 26A-D show simplified bottom views of microtiter plate 2600 resting on the vacuum plate (not within view). FIG. 26A shows a loading position where microtiter plate 2600 is generally positioned relative x-axis and y-axis alignment members 2606 and 2608. When generally positioned, microtiter plate 2600 is positioned such that y-axis alignment members 2608 are received into alignment member receiving area 2610 along the y-axis edge of the microtiter plate and x-axis alignment member 2606 is received into alignment member receiving area 2610 along the x-axis edge of the microtiter plate. Accordingly, in this embodiment the protrusions are positioned in alignment member receiving area 2610 between inner wall 2612 and outer wall 2604. It will be appreciated that the alignment members may cooperate with the microtiter plate in alternative configurations to place the microtiter plate in a generally positioned orientation. Further, to facilitate loading, both y-axis pusher 2613 and x-axis pusher 2618 are positioned away from microtiter plate 2600.

Referring now to FIG. 26B, y-axis pusher 2613 is moved so as to contact an outer y-axis edge of microtiter plate 2600. As described above, the pusher could also be arranged to contact an inner well surface of the microtiter plate. Y-axis pusher 2613 is moved with sufficient force to move plate 2600 into contact 2616 with wall 2604 of microtiter plate 2600. As y-axis pusher 2613 is pressed against microtiter plate 2600, the microtiter plate is moved, if necessary, to position inner wall 2612 against y-axis alignment members 2608. As y-axis pusher 2613 generally contacts the y-axis edge of microtiter plate 2600 in a central location, microtiter plate 2600 is moved with a minimum skewing force. In this manner, microtiter plate 2600 is firmly and reliably positioned in the y-axis.

With microtiter plate 2600 positioned in the y-axis, FIG. 26C shows that x-axis pusher 2618 is moved against an x-axis wall of microtiter plate 2600. In such a manner, x-axis pusher 2618 moves microtiter plate 2600 to position inner wall 2612 against x-axis alignment member 2606. While x-axis pusher 2618 is moving and holding plate 2600 against x-axis alignment member 2606, y-axis pusher 2613 remains pressed against the y-axis wall of microtiter plate 2600. To facilitate microtiter plate 2600 moving in the x-direction relative to contact 2616, contact 2616 is typically constructed to be a low friction element. For example, low friction contact point 2616 can be mounted on a spring-loaded member, which can keep a constant force against microtiter plate 2600 while permitting microtiter plate 2600 to be moved in the x-axis by x-axis pusher 2618. FIG. 22 shows an example of a suitable spring-loaded member. The contact point can also be coated with a low-friction material, such as TEFLON™, and the like. A low friction contact point can also be constructed by using a roller or rolling contact point, for example, or other means to reduce friction. A DELRIN™ ball plunger is another example of a suitable low friction contact point.

As shown in FIG. 26D, when microtiter plate 2600 has been moved into position (e.g., such that the orifices of the vacuum plate substantially align with regions disposed between adjacent wells of microtiter plate 2600) by x-axis pusher 2618, microtiter plate 2600 is precisely positioned for further processing. With plate 2600 precisely positioned, a vacuum source (not shown) is activated to securely draw microtiter plate 2600 against the vacuum plate to, e.g., flatten microtiter plate 2600. That is, vacuum is applied in a single stage whether via a single or multiple chambers. Accordingly, microtiter plate 2600 is securely retained in its precise position with any warping that may be present in the structure of microtiter plate 2600 compensated for, thereby allowing accurate and reliable further processing.

In certain embodiments, multi-well containers are positioned and retained in multi-well container positioning devices in stages or increments. This process can be useful, for example, when the stiffness of multi-well containers is high. In some of these embodiments, a multi-well container is positioned as described above with respect to FIGS. 26A-C followed by vacuum being applied to the microtiter plate in stages via multiple chambers. For example, with reference to multi-well container station 600, which is schematically illustrated in FIGS. 6 A and B, in a first stage vacuum can be applied via chamber 610 to a central portion of the container to hold the plate in position and prevent rocking of a warped multi-well container. This starts the flattening process of the multi-well container. In a second stage, vacuum is applied to an intermediate region of the multi-well container via chamber 608. Finally, in a third stage, the negative pressure is applied to the outermost region of the multi-well container via chamber 606 to completely flatten the container. Other sequences of applying vacuum to multi-well containers using devices having multiple chambers are also optionally utilized. As the stiffness or inflexibility of multi-well containers increases, the number of stages utilized to flatten the containers typically also increases. However, as mentioned above, suitable multi-well container flattening may be achieved using a single vacuum stage in certain cases (e.g., depending on the amount or level of negative pressure applied at the orifices of the vacuum plates, etc.).

The methods also typically include manually and/or robotically placing the multi-well containers in selected container stations of the multi-well container positioning device. For positioning device embodiments that include container stations that are coupled to support structures by rotational couplings, the methods also generally include rotating the rotationally coupled container station about the rotational axis to a selected position. In addition, the methods generally further include dispensing material (e.g., drug candidates and target molecules, samples comprising cells, combinatorial library members, labeled molecules, etc.) into and/or removing material from selected wells of the multi-well container with a material handling device, a material removal device, or the like. In certain embodiments, the methods further include detecting one or more detectable signals produced in one or more selected wells of the multi-well container with a detector. Essentially any biochemical or cellular assay can be adapted for performance in the systems of the invention. Exemplary assays optionally performed in the systems described herein include, e.g., intracellular calcium flux assays, membrane potential assays, nucleic acid hybridization assays among many others that are known in the art.

VI. Multi-Well Container Positioning Kits

The present invention also provides kits that include at least one component of the devices or systems described herein. For example, a kit optionally includes one or more vacuum plates having a selected orifice configuration, material dispensing or removal heads, tips, gaskets, resilient couplings (e.g., springs, formed elastomeric materials, etc.), and/or fastening components (e.g., screws, bolts, or the like) to assemble device or system components. In certain cases, kits include complete devices or systems that are optionally pre-assembled or unassembled. Optionally, kits include computer readable media that include one or more of the computer program products described herein. In addition, kits typically further include appropriate instructions for assembling, utilizing, and maintaining devices, systems, or components thereof. Kits also generally include packaging materials or containers for holding kit components.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

1. A multi-well container positioning device, comprising at least one support structure having at least one multi-well container station that comprises:
at least one vacuum plate that is structured to support at least one multi-well container, wherein at least one orifice is disposed through the vacuum plate, which orifice is configured to substantially align with a region of a bottom surface of the multi-well container that is disposed between at least two adjacent wells of the multi-well container when the multi-well container is positioned on the vacuum plate in a selected position; and,
at least one chamber that communicates with the orifice such that when negative pressure is applied in the chamber and the multi-well container is positioned on the vacuum plate in the selected position, the applied negative pressure retains the multi-well container in the selected position on the vacuum plate.

2. The multi-well container positioning device of claim 1, comprising multiple multi-well container stations.

3. The multi-well container positioning device of claim 1, wherein the applied negative pressure draws at least a portion of the bottom surface of the multi-well container toward the orifice to compensate for one or more structural defects or irregularities of the multi-well container, when the negative pressure is applied in the chamber and the multi-well container is positioned on the vacuum plate in the selected position.

4. The multi-well container positioning device of claim 1, wherein the orifice is configured to substantially align with a region of the bottom surface of the multi-well container that is disposed between four adjacent wells of the multi-well container when the multi-well container is positioned on the vacuum plate in the selected position.

5. The multi-well container positioning device of claim 1, wherein a center of the orifice and a midpoint of the region of the bottom surface of the multi-well container that is disposed between the adjacent wells are substantially coaxial with one another when the multi-well container is positioned on the vacuum plate in the selected position.

6. The multi-well container positioning device of claim 1, wherein the orifice comprises a cross-sectional shape selected from the group consisting of: a regular n-sided polygon, an irregular n-sided polygon, a tee, a cross, a triangle, a square, a rounded square, a rectangle, a rounded rectangle, a trapezoid, a circle, and an oval.

7. The multi-well container positioning device of claim 1, wherein the vacuum plate is structured to support multi-well containers that comprise 6, 12, 24, 48, 96, 192, 384, 768, 1536, 3456, 9600, or more wells.

8. The multi-well container positioning device of claim 1, wherein the multi-well container station comprises a heating element that adjustably regulates temperature in one or more wells of the multi-well container when the multi-well container is positioned on the vacuum plate and the heating element is operably connected to a power source.

9. The multi-well container positioning device of claim 1, comprising at least one position sensor coupled to the support structure, which position sensor is structured to detect the position of the multi-well container when the multi-well container is positioned on the vacuum plate.

10. The multi-well container positioning device of claim 1, wherein the multi-well container station comprises at least one lip surface disposed at least partially around the vacuum plate, which lip surface is recessed relative to the vacuum plate and is structured to receive a registration edge of an outer wall of the multi-well container when the multi-well container is positioned on the vacuum plate.

11. The multi-well container positioning device of claim 1, comprising at least one switch that generates a signal that indicates when the multi-well container is positioned in the selected position on the vacuum plate.

12. The multi-well container positioning device of claim 1, wherein multiple orifices are disposed through the vacuum plate and wherein each of the orifices is configured to substantially align with a different region of the bottom surface of the multi-well container that is disposed between two or more adjacent wells of the multi-well container when the multi-well container is positioned on the vacuum plate in the selected position.

13. The multi-well container positioning device of claim 12, comprising multiple chambers, wherein at least two of the chambers communicate with different orifices disposed through the vacuum plate.

14. The multi-well container positioning device of claim 13, wherein the chambers are concentrically disposed in the multi-well container station.

15. The multi-well container positioning device of claim 1, wherein the vacuum plate contacts the bottom surface of the multi-well container, which bottom surface underlies a well area of the multi-well container, when the multi-well container is positioned on the vacuum plate in the selected position.

16. The multi-well container positioning device of claim 15, wherein the applied negative pressure substantially conforms a shape of at least a portion of the bottom surface of the multi-well container to a contour of at least a portion of the vacuum plate, when the negative pressure is applied in the chamber and the multi-well container is positioned on the vacuum plate in the selected position.

17. The multi-well container positioning device of claim 16, wherein the applied negative pressure substantially flattens at least a portion of the multi-well container, when the negative pressure is applied in the chamber and the multi-well container is positioned on the vacuum plate in the selected position.

18. The multi-well container positioning device of claim 1, comprising at least one negative pressure source operably connected to the chamber.

19. The multi-well container positioning device of claim 18, wherein the negative pressure source comprises a vacuum source.

20. The multi-well container positioning device of claim 18, comprising multiple chambers operably connected to the negative pressure source via at least one valve that regulates the negative pressure applied by the negative pressure source in one or more of the chambers.

21. The multi-well container positioning device of claim 18, comprising at least one controller operably connected to the negative pressure source, which controller is configured to control the negative pressure applied by the negative pressure source.

22. The multi-well container positioning device of claim 21, comprising multiple chambers and multiple negative pressure sources, wherein the negative pressure sources communicate with different chambers, and wherein the controller is operably connected to each of the negative pressure sources and comprises at least one logic device having one or more logic instructions that direct the negative pressure sources to apply pressure in two or more of the chambers substantially simultaneously or in a selected sequence.

23. The multi-well container positioning device of claim 1, wherein the multi-well container station comprises at least one alignment member that is positioned to engage an inner wall of an alignment member receiving area of the multi-well container when the multi-well container is positioned on the vacuum plate.

24. The multi-well container positioning device of claim 23, wherein the multi-well container station comprises multiple alignment members extending from and/or proximal to the vacuum plate and wherein at least two of the alignment members are positioned to engage different inner walls of the alignment member receiving area of the multi-well container when the multi-well container is positioned on the vacuum plate.

25. The multi-well container positioning device of claim 23, wherein the multi-well container station comprises multiple alignment members that together form a nest that is structured to receive the multi-well container when the multi-well container is positioned on the vacuum plate.

26. The multi-well container positioning device of claim 25, wherein at least one of the multiple alignment members comprises an angled surface that is configured to direct the multi-well container into the nest when the multi-well container is placed into the nest.

27. The multi-well container positioning device of claim 23, wherein the alignment member comprises a curved surface that is structured to engage the inner wall of the alignment member receiving area of the multi-well container.

28. The multi-well container positioning device of claim 27, wherein the alignment member comprises a locating pin that extends from or proximal to the vacuum plate.

29. The multi-well container positioning device of claim 23, comprising one or more pushers coupled to the support structure, which pushers are configured to push the multi-well container into contact with the alignment member when the multi-well container is positioned on the vacuum plate.

30. The multi-well container positioning device of claim 29, wherein multiple pushers are coupled to the support structure and wherein at least two of the pushers are configured to push the multi-well container in different directions when the multi-well container is positioned on the vacuum plate.

31. The multi-well container positioning device of claim 29, comprising at least one controller operably connected to at least one of the pushers, which controller directs the pusher to push the multi-well container into contact with the alignment member when the multi-well container is positioned on the vacuum plate.

32. The multi-well container positioning device of claim 29, wherein at least one of the pushers comprises a low friction contact point that is structured to contact the multi-well container when the multi-well container is positioned on the vacuum plate.

33. The multi-well container positioning device of claim 32, wherein the low friction contact point comprises a roller.

34. The multi-well container positioning device of claim 29, comprising at least one lever arm pivotally coupled to the support structure by a pivotal coupling, wherein at least a first of the pushers is configured to push the lever arm such that the lever arm pivots to push the multi-well container into contact with the alignment member when the multi-well container is positioned on the vacuum plate.

35. The multi-well container positioning device of claim 34, wherein the lever arm is coupled to a resilient coupling that causes the first pusher to apply a constant force to the multi-well container in order to push the multi-well container in a first direction when the multi-well container is positioned on the vacuum plate.

36. The multi-well container positioning device of claim 35, wherein the resilient coupling comprises a spring.

37-112. (canceled)
